(19) United States
(12) Patent Application Publication
(10) Pub. No.: US 2020/0226602 A1
(43) Pub. Date: Jul. 16, 2020

(54) METHODS AND SYSTEMS FOR AVAILING OFFERS IN CARD BASED PAYMENT TRANSACTION

(71) Applicant: MASTERCARD INTERNATIONAL INCORPORATED, Purchase, NY (US)

(72) Inventors: Abhishek Chaturvedi, Lucknow (IN); Prasenjit Bhattacharjee, Agartala (IN); Akshay Varma, Thane District (IN); Ashish Yeshwant Bhosale, Pune (IN); Parameswaran Venkatasubramanian, Chennai (IN); Lakshmi Narasimhan Ramanujam, Chennai (IN)

(73) Assignee: MASTERCARD INTERNATIONAL INCORPORATED, Purchase, NY (US)

(21) Appl. No.: 16/739,379

(22) Filed: Jan. 10, 2020

(30) Foreign Application Priority Data
Jan. 14, 2019 (SG) 10201900318Y

(51) Int. Cl. G06Q 20/40; G06Q 30/02

(52) U.S. Cl. CPC G06Q 20/4014; G06Q 30/0222; G06Q 20/409

(57) ABSTRACT

Systems and methods for facilitating a transaction between a cardholder, registered with a first payment entity, and a second payment entity other than the first payment entity in cases when the second payment entity promotes an offer which the cardholder wants to avail. The method includes receiving a first service request from a user at a server system associated with the first payment entity. The first service request is a request to avail the offer using a first payment card of the user. The method further includes facilitating authentication of the first service request at the first payment entity. Upon successful authentication, the method includes sending a second service request to second payment entity and receiving approval from the second payment entity for availing the offer. The method further includes receiving a second payment card from second issuing entity, where the second payment card is eligible for availing the offer.

### TECHNICAL FIELD

The present disclosure relates to financial transactions and, more particularly to, methods and systems facilitating a transaction between a cardholder, registered with a first payment entity, and a second payment entity other than the first payment entity to avail an offer provided by the second payment entity.

### BACKGROUND

Digital payments have emerged as the convenient and reliable way of making payments and have seen a drastic increase due to ease of usage and also provide hassle-free experience to the customers by eliminating need of carrying cash in their wallets. Moreover, people prefer the use of payment cards (e.g., credit card, debit card) for financial transactions at point-of-sale terminals of merchant facilities such as, retail establishments, online stores or businesses (e.g., ticket reservation centers) that handle cash or credit transactions. The various banking cards are referred to herein as payment cards.

Buying commodities or services using payment cards has become the most preferred mode of transaction because of the ease and convenience it imparts. To attract more and more users into digital money transaction, the payment servers or issuing banks provides luring offers to their users such as discounts on purchasing a commodity or for availing a service using cards for example flat 20% off on booking a flight ticket or shopping for groceries, 5% cashback on paying bills etc. However, users who are registered i.e. have financial accounts with the payment server or the issuing bank can avail only those offers that are provided by their issuing bank or payment server but other users who are not registered can not avail the offer. To avail multiple offers from multiple financial institutions the user should have his/her financial account in all the financial institutions providing offers. Maintaining financial accounts in many institutions may not be feasible for the user, and the user may miss out on good offers. Therefore, there is a need to develop a process or system to overcome above stated problem.

### SUMMARY

Various embodiments of the present disclosure provide systems, methods, electronic devices and computer program products for availing an offer for card based transactions at merchant terminals.

In an embodiment, a method includes receiving a first service request from a cardholder at a server system associated with a first payment entity. The first service request is a request to avail an offer using a first payment card of the cardholder associated with the first payment entity and the wherein the offer provided by a second payment entity. The method further includes facilitating authentication of the first service request at the first payment entity. Upon successful authentication of the first service request, the method includes sending a second service request to the second payment entity. The method further includes receiving a permission from the second payment entity for availing the offer based on the second service request. The method further includes receiving a second payment card from the second issuing entity. The second payment card is eligible for availing the offer provided by the second payment entity.

In another embodiment, a system associated with a payment network is disclosed. The system includes a memory comprising stored instructions and at least one processor configured to execute the stored instructions to cause a server system to perform a method. The method includes receiving a first service request from a cardholder at a server system associated with a first payment entity. The first service request is a request to avail an offer using a first payment card of the cardholder associated with the first payment entity and the offer provided by a second payment entity. The method further includes facilitating authentication of the first service request at the first payment entity. Upon successful authentication of the first service request, the method includes sending a second service request to the second payment entity. The method further includes receiving a permission from the second payment entity for availing the offer based on the second service request. The method further includes receiving a second payment card from the second issuing entity. The second payment card is eligible for availing the offer provided by the second payment entity.

In yet another embodiment, a method includes receiving a first service request from a cardholder at a server system associated with a first payment entity. The first service request is a request to avail an offer using a first payment card of the cardholder associated with the first payment entity and the offer provided by a second payment entity. The method further includes facilitating authentication of the first service request at the first payment entity. Upon successful authentication of the first service request, the method includes sending a second service request to the second payment entity. The method further includes receiving a permission from the second payment entity for availing the offer based on the second service request. The method further includes receiving a second payment card from the second issuing entity. The second payment card is eligible for availing the offer provided by the second payment entity. The method further includes sharing the second payment card with the cardholder via the server system.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 illustrates a sequence flow diagram representing a method of registration for a PayLateAuthForwd service at a service portal and generation of a virtual card, in accordance with an embodiment of the present disclosure;

FIG. 3 illustrate a sequence flow diagram representing a method of performing a transaction using the PayLateAuthForwd service, in accordance with an embodiment of the present disclosure;

FIG. 4 illustrates a sequence flow diagram representing yet another method of registration for a PayLateAuthForwd service at a service portal and generation of a virtual card, in accordance with an embodiment of the present disclosure;

FIG. 5 illustrates a sequence flow diagram representing yet another method of performing a transaction using the PayLateAuthForwd service, in accordance with an embodiment of the present disclosure;

FIG. 6 illustrates a flow diagram representing a method of registration for a PayLateAuthForwd service at a service portal and generation of a virtual card, in accordance with an embodiment of the present disclosure;

FIG. 7 illustrates a flow diagram representing method of performing a transaction using the PayLateAuthForwd service, in accordance with an embodiment of the present disclosure;

FIGS. 8A and 8B, in conjunction, illustrate a flow diagram representing yet another method of facilitating registration for a PayLateAuthForwd service at a service portal and generation of a virtual card for a transaction made using the PayLateAuthForwd service, in accordance with an example embodiment of the present disclosure;

FIG. 9 illustrates a flow diagram representing yet another method of performing a transaction using the PayLateAuthForwd service, in accordance with an embodiment of the present disclosure;

FIG. 10 a simplified block diagram of a server system for rendering a service (e.g., the PayLateAuthForwd service) to the cardholder, in accordance with an embodiment of the present disclosure;

FIG. 11 illustrates a flow diagram of a method for performing a transaction using the PayLateAuthForwd service, in accordance with an example embodiment of the present disclosure;

FIGS. 12A and 12B, in conjunction, show an example representation of a UI displayed on a display screen of the user device for registration for the PayLateAuthForwd service, in accordance with an example embodiment of the present disclosure;

FIG. 13 illustrates an example representation of a UI displayed on a display screen of the user device configured to facilitate provision of raising a service request at the service portal, in accordance with an example embodiment of the present disclosure;

FIG. 14 is a simplified block diagram of a merchant terminal used for card based payment transaction, in accordance with an example embodiment of the present disclosure;

FIG. 15 is a simplified block diagram of an issuer server used for performing payment of at least a part of a transaction amount with a payment card, in accordance with an example embodiment of the present disclosure;

FIG. 16 is a simplified block diagram of an acquirer server used for processing payment transactions at a merchant terminal, in accordance with an example embodiment of the present disclosure; and

FIG. 17 is a simplified block diagram of a payment server used for providing PayLateAuthForwd service to the cardholder, in accordance with an example embodiment of the present disclosure;

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuing server” used throughout the description refers to a server that holds a financial account that is used to fund the financial transaction (interchangeably referred to as “card payment transaction”) of a cardholder. Further, the term “acquiring server” used throughout the description refers to a server that holds a financial account of a merchant or any entity which receives the fund from the issuing server. Examples of the issuing server and the acquiring server include, but are not limited to a bank, electronic payment portal such as PayPal®, and a virtual money payment portal. The financial accounts in each of the issuing server and the acquiring server may be associated with an entity such as an individual person, a family, a commercial entity, a company, a corporation, a governmental entity, a non-profit organization and the like. In some scenarios, the financial account may be a virtual or temporary payment account that can be mapped or linked to a primary payment account, such as those accounts managed by PayPal®, and the like.

The term “payment card”, used throughout the description, refers to a physical or virtual card linked with a financial or payment account that may be presented to a merchant or any such facility in order to fund a financial transaction via the associated payment account. Examples of the payment card includes, but are not limited to, debit cards, credit cards, prepaid cards, digital wallet, virtual payment numbers, virtual card numbers, forex card, charge cards and stored-value cards. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

The term “payment server”, used throughout the description, refers to a network or collection of systems used for transfer of funds through use of cash-substitutes. Payment servers may use a variety of different protocols and procedures in order to process the transfer of money for various types of transactions. Transactions that may be performed via a payment server may include product or service purchases, credit purchases, debit transactions, fund transfers, account withdrawals, etc. Payment servers may be configured to perform transactions via cash-substitutes, which may include payment cards, letters of credit, checks, financial accounts, etc. Examples of networks or systems configured to perform as payment servers include those operated by Mastercard®, VISA®, Discover®, American Express®, etc.

### Overview

Various example embodiments of the present disclosure provide methods and systems for facilitating a transaction between a cardholder, registered with a first payment entity, and a second payment entity other than the first payment entity. The second payment entity is promoting an offer which the cardholder wants to avail. The first payment entity and the second payment entity are connected via a server system. The embodiments facilitate the cardholder with provision of availing an offer provided by the second payment entity by registering to a service portal and opting for a pay later authentication forwarding (hereinafter, “PayLateAuthForwd”) service. The service portal acts as a gateway and redirects the registration request to a payment server hosting the service portal. The registration includes providing email Identified (email ID) and mobile number, and creating login credentials such as User ID and password for future login into the payment service portal. In order to opt for the PayLateAuthForwd service, the cardholder will login into the payment service portal, select the PayLateAuthForwd service option and provide details such as card number, name on the card, expiry date, CVV, a transaction amount limit, a time period limit, and name of the second payment entity. Once the cardholder submits the service request for opting the PayLateAuthForwd service along with details at the payment service portal, the service portal redirects the service request to the payment server. The payment server identifies the first payment entity associated with the cardholder's primary card and sends the service request along with the details to the first payment entity for authentication and approval on the transaction amount limit and the time period limit requested by the cardholder.

The first payment entity puts hold on the transaction amount in the cardholder's account in the first payment entity after approving the transaction amount limit requested in the service request. After receiving the approval from the first payment entity, the payment server sends a message to the second payment entity requesting to issue a virtual card. After receiving the virtual card from the second payment entity, the payment server maps the virtual card against the card number provided by the cardholder in the service request. The virtual card mapped against the card number for the service request are stored in the payment server for future use. Now, the payment server either provides the complete details of the virtual card to the cardholder or sends a notification that the request is accepted and the cardholder is now eligible to avail the PayLateAuthForwd service.

The cardholder can avail the service now for transactions made during the time period limit requested by the cardholder and can spend up to the transaction amount limit only using the PayLateAuthForwd service. When the cardholder performs a transaction, using either the primary card or the virtual card whichever he has the possession, at a merchant terminal during the time period limit in which the PayLateAuthForwd service is applicable, the transaction is routed to the payment server which identifies that the cardholder is eligible for the PayLateAuthForwd service and reads the details of either the primary card mapped to the virtual card or of the virtual card whichever is used by the cardholder. The payment server then identifies the second payment entity and routes the transaction request to the second payment entity for approval on availing the offer by the cardholder. The payment server, after receiving the approval from the second payment entity, provides the transaction amount to the acquiring server of the merchant facility and the cardholder avails the offer. The cardholder will be charged for the transaction made during the time period after the time period limit ends.

When the time period limit expires the payment server sends a clearing service request to the first payment entity, and receives the total transaction amount spend by the cardholder using the PayLateAuthForwd service. Alternatively, the payment server can also send the clearing service request after each transaction made during the PayLateAuthForwd service.

Several aspects and example embodiments of the present disclosure are provided in the drawings and the detailed description that follows.

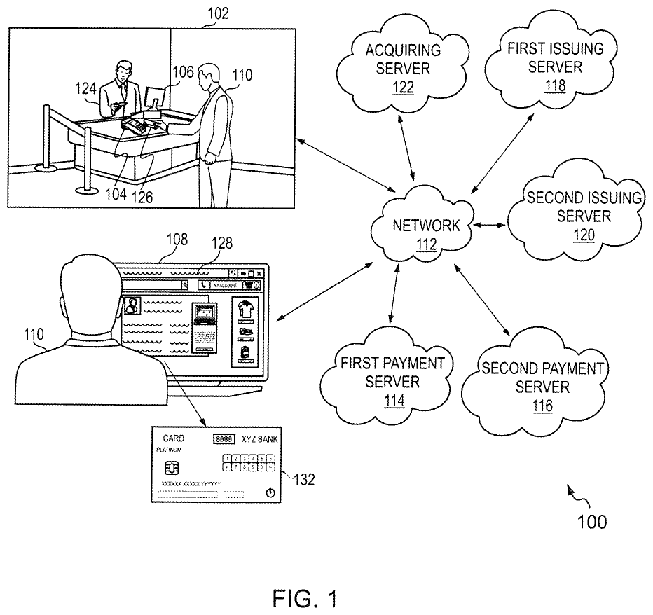

FIG. 1 illustrates an exemplary representation of an environment 100, in which at least some example embodiments of the present disclosure can be implemented. The environment 100 is exemplarily shown including a merchant facility 102 (also referred to herein as ‘a merchant 102 or ‘a merchant terminal 102’) equipped with a POS terminal 104 and a merchant interface device 106, a user device 108 associated with a cardholder 110, a network 112, a first payment server 114, a second payment server 116, a first issuing server 118, a second issuing server 120, and an acquiring server 122. Examples of the merchant 102 may include any retail establishments such as, restaurant, supermarket or business establishments such as, government and/or private agencies, toll gates, parking lot or any such place equipped with POS terminals, such as the POS terminal 104 or commercial website establishments such as, restaurant, supermarket or business establishments such as, government and/or private agencies, toll gates, parking lot or any such place where customers visit for performing financial transaction in exchange for any goods and/or services or any transaction that requires financial transaction between customers and a merchant. In various embodiments, the merchant interface device 106 can be a telephone or a computer system operated by an agent 124 for performing payment transactions on behalf of a customer, for example, a cardholder 110 using a payment card 126. The user device 108 may be a portable user device. Examples of the portable user device 108 include, but are not limited to, a smart phone, a personal digital assistant (PDA), and a laptop, among others. In some embodiments, the user device 108 may be a non-portable user device. Examples of the non-portable user device 108 include a personal computer (PC) and a kiosk, among others. The user device 108 may be a device that the user (e.g., the cardholder 110) operates to browse a website 128 and to perform a transaction. The cardholder 110 represents a customer visiting a website (e.g. the website 128) over the internet, and performing a transaction to buy a product or a service.

The first payment server 114 and the second payment server 116 facilitate transactions by the transfer of information between the acquiring server 122 and the first issuing server 118 and the second issuing server 120 via the network 112. The first issuing server 118 and the second issuing server 120 are associated with a financial institution normally called as an “issuer bank” or “issuing bank” or simply “issuer” or simply “bank”, in which the cardholder 110 may have an issuer account, which issues one or more payment cards, such as a credit card or a debit card. The payment cards are linked to an issuer account associated with a unique payment account number of the cardholder 110. The cardholder 110 can use any of the payment cards to tender payment for the purchase. The issuer bank is responsible for determining whether a customer's issuer account is in good standing and whether the purchase is covered by the customer's available credit line or account balance. Based on these determinations, the payment transaction associated with the payment transaction request is approved or declined.

The acquiring server 122 is associated with a financial institution normally called as a “merchant bank” or the “acquiring bank” or “acquirer bank” or simply “acquirer”, in which the merchant 102 may have a merchant account. The acquiring server 122 is associated with the acquirer bank. Using the network 112, the acquiring server 122 will communicate with either the first issuing server 118 or the second issuing server 120 to determine whether the cardholder's account is in good standing and whether the transaction amount of the purchase is covered by the cardholder's available account balance. Based on these determinations, authorization of the transaction is declined or accepted. When the authorization is accepted, the available balance of cardholder's account is decreased.

The payment card 126 is issued by the first issuing server 118 in association with the second payment server 116. The merchant 102, the user device 108, the first payment server 114, the second payment server 116, the first issuing server 118, the second issuing server 120, and the acquiring server 122 are communicatively coupled with each other via the network 112.

In an example application scenario, the cardholder 110 makes a transaction at the merchant 102 or at a website via the user device 108 for purchasing a product or a service which has an ongoing offer. The offer is provided by the second payment server 116 in association with the second issuing server 120. In order to avail the offer the cardholder 110 will register for a PayLateAuthForwd service on a service portal 130 (shown in FIG. 13) to enter into the first payment server 114. The cardholder 110 can register on the service portal 130 by accessing the website 128 hosted by the first payment server 114. During the registration process, the cardholder 110 provides details such as name, permanent address, email-id, identity proof details etc., on the service portal 130 and creates login credentials including UserID and password for future access at the service portal 130. In a non-limiting manner, the first issuing server 118 and the second issuing server 120 may have come to an agreement of providing a facility for the cardholder 110 in which a virtual card 132 can be generated by the second issuing server 120, and mapped with the payment card 126 based on selection of PayLateAuthForwd service by the cardholder 110. In a non-limiting manner, the PayLateAuthForwd service renders an option to the cardholder 110 to perform a transaction without paying any money at the time of making the transaction and can choose a timeline within the cardholder 110 can pay back the money. The PayLateAuthForwd service also renders an option to the cardholder 110 to select the second issuing server 120 for providing the virtual card 132 so that the cardholder 110 can avail the offer provided by the second issuing server 120 while making the transaction to purchase the product or the service having the offer.

The cardholder 110 logins into the service portal 130 using the login credentials, selects the PayLateAuthForwd service option and provide details such as card number, name on the card, expiry date, CVV, a transaction amount limit, a time period limit, and name of the second issuing server 120. The card number is card number of the payment card 126, name on the card is the name of the cardholder 110 present on the payment card 126, expiry date indicates the validity period of the payment card 126, the transaction amount limit indicates maximum amount of money the cardholder 110 is eligible to receive and spend under the PayLateAuthForwd service, and the time period limit indicates the timeline with in which the cardholder 110 is entitled to pay back the money he/she spent using the PayLateAuthForwd service.

Once the cardholder 110 submits a service request for opting the PayLateAuthForwd service along with the aforementioned details at the service portal 130, the service portal 130 redirects the service request to the first payment server 114. Upon receiving the service request, the first payment server 114 identifies the second payment server 116 associated with the cardholder's payment card 126 and sends the service request including the aforementioned details to the second payment server 116. The second payment server 116 identifies the first issuing server 118 and sends the service request to the first issuing server 118 for authentication and approval on the transaction amount limit and the time period limit requested by the cardholder 110. The first issuing server 118 puts hold on money equivalent to the transaction amount limit in the cardholder's account in the first issuing server 118 after approving the transaction amount limit requested in the service request. Upon receiving the approval from the first issuing server 118, the first payment server 114 will send a message to the second issuing server 120 requesting to issue a virtual card 132. Upon receiving the virtual card 132 from the second issuing server 120, the first payment server 114 tokenizes the virtual card 132 and maps the tokenized virtual card 132 against the card number of the payment card 126. The mapped tokenized virtual card 132 along with the payment card 126 are stored in the first payment server 114 for future use. The first payment server 114 provides the virtual card 132 to the cardholder 110 via the service portal 130. Alternatively, the first payment server 114 provides masked card number of the virtual card 132 to the cardholder 110, and sends a notification that the request is accepted and the cardholder 110 is now eligible to avail the PayLateAuthForwd service. Masking of card number indicates that few numbers in the card number of the virtual card 132 will be hidden or overridden by some characters and hence not visible to the cardholder 132. The cardholder 110 can avail the service now for transactions made during the time period limit requested by the cardholder 110 and can spend money maximum up to the transaction amount limit using the PayLateAuthForwd service.

In at least one example embodiment, the cardholder 110 performs the transaction using the virtual card 132 at the merchant 102 or at any merchant website hosted by the merchant 102 during the time period limit in which the PayLateAuthForwd service is applicable. The transaction is routed to the first payment server 114 via the acquiring server 122 because the cardholder 110 is a registered member of the first payment server 114. The first payment server 114 identifies that the cardholder 110 is eligible for the PayLateAuthForwd service and reads the details of the virtual card 132. The first payment server 114 then identifies the second issuing server 120 and routes the transaction request to the second issuing server 120 for approval on availing the offer. Upon receiving the approval from the second issuing server 120, the first payment server 114 provides the transaction amount to the acquiring server 122 of the merchant facility 102. The cardholder 110 gets the benefit of the offer during the transaction.

In at least one alternate example embodiment, the cardholder 110 performs the transaction using the payment card 126 because the virtual card 132 was not shared with the cardholder 110. The transaction is routed to the first payment server 114 which identifies that the cardholder 110 is eligible for the PayLateAuthForwd service and reads the details of the payment card 126. The first payment server 114 identifies the mapped virtual card 132 against the payment card 126. The first payment server 114 then identifies the second issuing server 120 based on the virtual card 132 and routes the transaction request to the second issuing server 120 for approval on availing the offer. Upon receiving the approval from the second issuing server 120, the first payment server 114 provides the transaction amount to the acquiring server 122 of the merchant facility 102. The cardholder 110 gets the benefit of the offer during the transaction.

In a non-limiting example, the cardholder 110 is charged for the transaction made during the time period after the time period limit mentioned in the service request ends. When the time period limit expires, the first payment server 114 sends a clearing service request to the second payment server 116, and receives the total transaction amount spend by the cardholder 110 using the PayLateAuthForwd service. Alternatively, the first payment server 114 can also send the clearing service request to the second payment server 116 after each transaction made by the cardholder 110 during usage of the PayLateAuthForwd service.

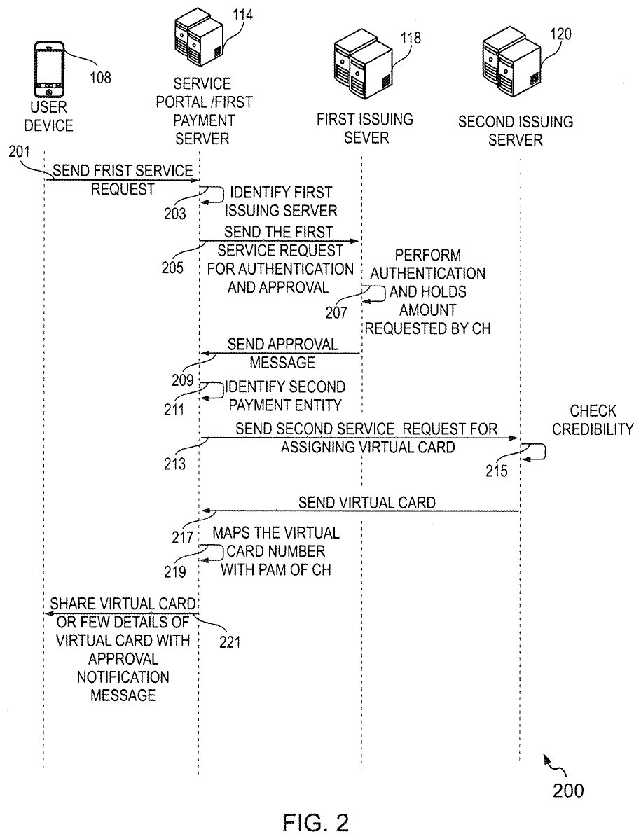

FIG. 2 illustrates a sequence flow diagram representing a method 200 of registration for a PayLateAuthForwd service at a service portal 130 and generation of a virtual card 132 for a transaction made using the PayLateAuthForwd service by the cardholder 110 in accordance with an example embodiment. At 201, the cardholder 110 sends a first service request to the service portal 130 to opt for the PayLateAuthForwd service after completing the login procedure at the service portal 130. The service portal 130 acts as a gateway and redirects the first service request to a first payment entity such as the first payment server 114. The cardholder 110 has the payment card 126, for example, but not limited to, a credit card or a debit card. The payment card 126 is issued by the first issuing server 118. The cardholder 110 provides details such as card number of the payment card 126, name on the card, expiry date, CVV, a transaction amount limit, a time period limit, and name of the second payment entity 118 in the service request. The cardholder 110 can raise the first service request via a website (for example, the website 128) hosted by the first payment server 114 to access the service portal 130. Alternatively, the cardholder 110 can raise the first service request by calling to a customer care number of the first payment server 114.

At 203, first payment server 114 identifies the first issuing server 118 based on the details received from the cardholder 110 in the first service request. At 205, the first payment server 114 facilitates authentication of the first service request. In an embodiment, the first payment server 114 facilitates authentication by sending the first service request to the identified first issuing server 118 for authentication of the details provided by the cardholder (CH) 110 such as, but not limited to, name on the payment card 126, the card number of the payment card 126, expiry date and CVV, and to seek approval on the transaction amount limit and the time period limit mentioned in the first service request. The authentication is performed by cross verifying details of the cardholder 110 pre-stored at a database of the first issuing server 118.

At 207, the first issuing server 118 receives the first service request and authenticates the details in the first service request, and performs a check on the transaction amount limit and the time period limit before providing the approval. The first issuing server 118 holds an amount equivalent to the transaction amount limit in the cardholder's account present in the first payment entity 114. At 209, the first issuing server 118 sends the approval to the first payment server 114.

At 211, upon receiving the approval from the first issuing server 118, the first payment server 114 identifies a second payment entity such as the second issuing server 120 based on the details given in the first service request by the cardholder 110. It is noted that the cardholder 110 chose the second issuing server 120 to avail an offer provided by the second issuing server 120 (an example of the second payment entity) while purchasing a product or service. The first payment server 114 may also render information at the service portal 130 regarding offers provided by different payment entities. Therefore the cardholder 110 may decide which issuing entity to choose as the second issuing server 120 after logging into the service portal 130 via the website 128.

At 213, the first payment server 114 sends a second service request to the second issuing server 120 to issue a virtual card 132 and shares the details provided by the cardholder 110 in the first service request with the second issuing server 120. At 215, the second issuing server 120 checks credibility of the cardholder 110 based on the details provided by the cardholder 110 in the second service request. Post assuring the credibility, the second issuing server 120 issues the virtual card 132. At 217, the second issuing server 120 shares the virtual card 132 with the first payment server 114.

At 219, upon receiving the virtual card 132, the first payment server 114 maps the virtual card 132 with the payment card 126 and stores the mapped virtual card 132 and the payment card 126 in a database for future reference and use.

At 221, the first payment server 114 shares the virtual card 132 with the cardholder 110 via the service portal 130. Alternatively or additionally, the first payment server 114 shares masked card number of the virtual card 132 along with a notification message indicating that the cardholder 110 is eligible to avail the PayLateAuthForwd service.

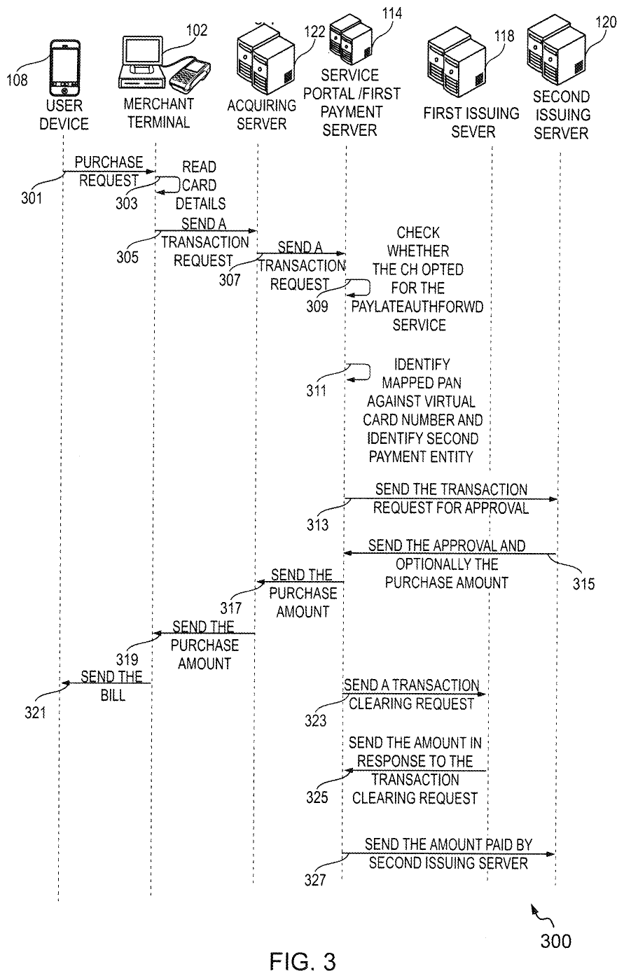

FIG. 3 illustrates a sequence flow diagram representing a method 300 of performing a transaction using the PayLateAuthForwd service in accordance with an example embodiment. At 301, the cardholder 110 sends a purchase request to purchase a product or a service at the merchant 102. The purchase request indicates buying a product or a service at the merchant 102 using any payment card (for example the payment card 126 or the virtual card 132) such as debit card, credit card etc. It is herein assumed that the purchase of the product or the service comes with an offer if bought by a card (such as the virtual card 132) issued by the second issuing server 120.

At 303, in an example embodiment, the merchant 102 receives the purchase request and reads the details of the payment card 126 or the virtual card 132 whichever is presented by the cardholder 110 to purchase the product or the service. The cardholder 110 uses the virtual card 132 to purchase the product or the service in a case where the virtual card 132 was shared with the cardholder 110, otherwise the cardholder 110 uses the payment card 126.

At 305, the merchant 102 sends a transaction request including the details of the payment card 126 or the virtual card 132, and a price of the product or the service to the acquiring server 122. The transaction request indicates a transaction performed by the cardholder 110 at the merchant 102 to buy the product or the service. At 307, the acquiring server 122 sends the transaction request to the first payment server 114.

At 309, the first payment server 114 checks whether the cardholder 110 has opted for the PayLateAuthForwd service against the payment card 126 or the virtual card 132 used for the transaction. The first payment server 114 verifies that the cardholder 110 has opted for the PayLateAuthForwd service based on mapping the payment card 126 with the virtual card 132 or vice versa.

At 311, the first payment server 114 identifies the second issuing server 120 (i.e. the second payment entity) based on the details of the virtual card 132 extracted from the database of the first payment server 114. At 313, the first payment server 114 sends the transaction request to the second issuing server 120 for approval on availing the offer for the transaction made by the cardholder 110.

At 315, the second issuing server 120 sends the approval for availing the offer for the transaction using the issued virtual card. Alternatively or additionally, the second issuing server 120 can send the amount equivalent to the price of the product or the service after applying the offer to the first payment server 114. At 317, the first payment server 114 sends the amount received from the second issuing server 120 to the acquiring server 122. In an alternate embodiment, the first payment server 114 directly sends the amount equivalent to the price of the product or the service after applying the offer to the acquiring server 122.

At 319, the acquiring server 122 sends the amount to the merchant 102. At 321, the merchant 102 provides a bill receipt of the product or the service purchased by the cardholder 110 along with the product or the service.

At 323, in an example embodiment, the first payment server 114 sends a clearing request to the first issuing server 118 including the amount paid by the first payment server 114 or by the second issuing server 120 for the transaction performed by the cardholder 110 using the PayLateAuthForwd service along with a service charge for rendering use of the PayLateAuthForwd service. Alternatively, the first payment server 114 sends the clearing request for all the transactions made by the cardholder 110 during the time period limit after the time period limit expires.

At 325, the first issuing server 118 sends the amount to the first payment server 114 in response of the clearing service request. At 327, the first payment server 114 sends the amount, paid by the second issuing server 120 during use of the PayLateAuthForwd service, by the cardholder 110, to the second issuing server 120.

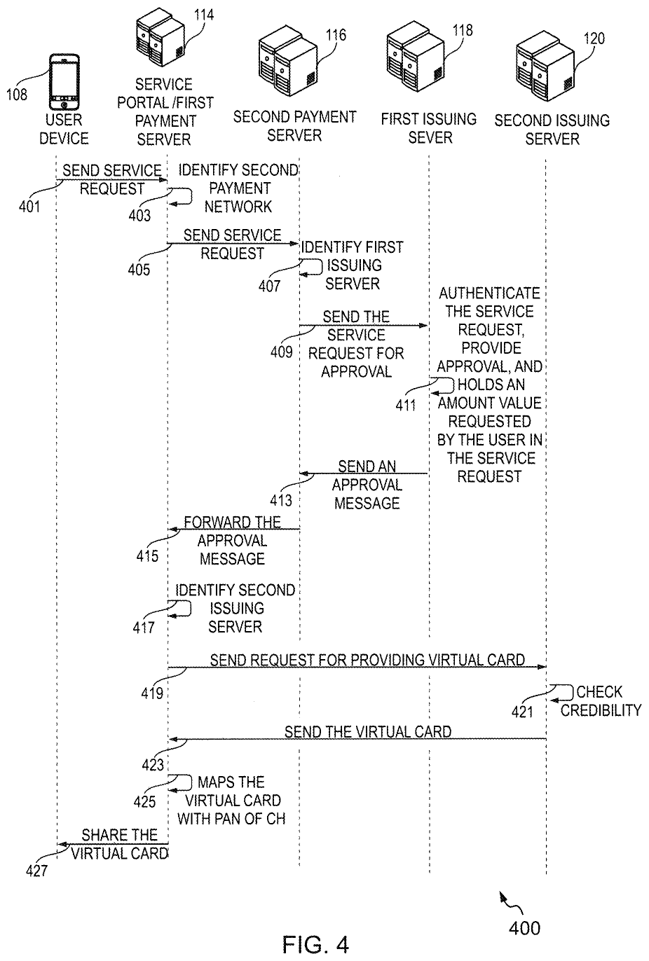

FIG. 4 illustrates a sequence flow diagram representing yet another method 400 of registration for a PayLateAuthForwd service at a service portal 130 and generation of a virtual card 132 for a transaction made using the PayLateAuthForwd service in accordance with an example embodiment.

At 401, the cardholder 110 sends a service request to the service portal 130 to opt for the PayLateAuthForwd service after completing a login procedure at the service portal 130. The cardholder 110 has a payment card 126 issued by the first issuing server 118 in association with the second payment server 116. The cardholder 110 provides details such as card number, name on the card, expiry date, CVV, a transaction amount limit, a time period limit, and name of the second issuing server 120 in the service request. The cardholder 110 can raise the service request via a website (for example, the website 128) hosted by the first payment server 114 to access the service portal 130. The service portal 130 acts as a gateway and redirects the service request to the first payment server 114. Alternatively, the cardholder 110 can raise the service request by calling to a customer care number of the first payment server 114, and providing all the details including the card number of the payment card 126, name on the card, expiry date, CVV, the transaction amount limit, the time period limit, and name of the second issuing server 120.

The transaction amount limit is updated after every transaction made by the cardholder 110 during usage of the PayLateAuthForwd service. For example, without limiting to the scope of the present disclosure, the transaction amount limit was set as 1000 INR at the time of registration, when the cardholder 110 will perform a transaction of amount 500 INR then the transaction amount limit will be updated based on subtracting the previous transaction amount limit with the amount of purchase made in the transaction i.e. 1000−500 INR=500 INR.

At 403, the first payment server 114 identifies the second payment server 116 based on the details of the payment card 126 shared by the cardholder 110 in the service request. At 405, the first payment server 114 sends the service request to the second payment server 116. The second payment server 116 functions as a secure passage of information between the merchant 102, acquiring server 122 or first payment server 114 and the first issuing server 118 for transactions.

At 407, the second payment server 116 identifies the first issuing server 118 associated with the payment card 126. The second payment card 126 identifies the first issuing server 118 based on the details of the payment card 126 received in the service request sent by the first payment server 114.

At 409, the second payment server 116 sends the service request to the first issuing server 118 for approval on the transaction amount limit and the time period limit and also for the authentication of the details of the payment card 126 provided by the cardholder 110 in the service request.

At 411, the first issuing server 118 authenticates the details of the payment card 126 provided by the cardholder 110 in the service request, and checks whether the cardholder 110 has sufficient fund in his/her account at the first issuing server 118 in order to be eligible to avail the PayLateAuthForwd service with the mentioned transaction amount limit. For example, the first issuing server 118 can specify a criteria that the account balance of the cardholder 110 must be four times than the transaction amount limit in order to make the cardholder 110 eligible for availing the PayLateAuthForwd service. Further, the time period limit shall also expire before the expiry date of the payment card 126. Accordingly, the first issuing server 118 approves the transaction amount limit and the time period limit. The first issuing server 118 holds an amount equivalent to the transaction amount limit in the account of the cardholder 110.

At 413, the first issuing server 118 sends an approval message to the second payment server 116 indicating approval on eligibility of the cardholder 110 for availing the PayLateAuthForwd service for the transaction amount limit and the time period limit.

At 415, the second payment server 116 forwards the approval message to the first payment server 114. At 417, the first payment server 114 identifies the second issuing server 120 based on the details (i.e. name of the second issuing server 120) provided by the cardholder 110 in the service request.

At 419, the first payment server 114 sends a request to the second issuing server 120 for issuing a virtual card 132 and shares the details such as card number of the payment card 126.

At 421, the second issuing server 120 checks creditability score of the payment card 126 based on market standards programs for checking the creditability of any credit or debit cards. The second issuing server 120 issues the virtual 132 based on the creditability score analysis of the payment card 126. At 423, the second issuing server 120 sends the virtual card 132 to the first payment server 114.

At 425, the first payment server 114 maps the received virtual card 132 from the second issuing server 120 with the payment card 126 issued by the first issuing server 118, and saves this mapping information in a database of the first payment server 114 for future reference and use. The first payment server 114 tokenizes the virtual card for security purposes. The tokenized virtual card is also saved along with the mapping information in the database.

At 427, the first payment server 114 shares the tokenized virtual card 132 with the cardholder 110. The virtual card 132 may comprise a temporary card or a permanent card. In an alternate embodiment, the second issuing server 120 may also issue a physical card based on a request for the cardholder 110.

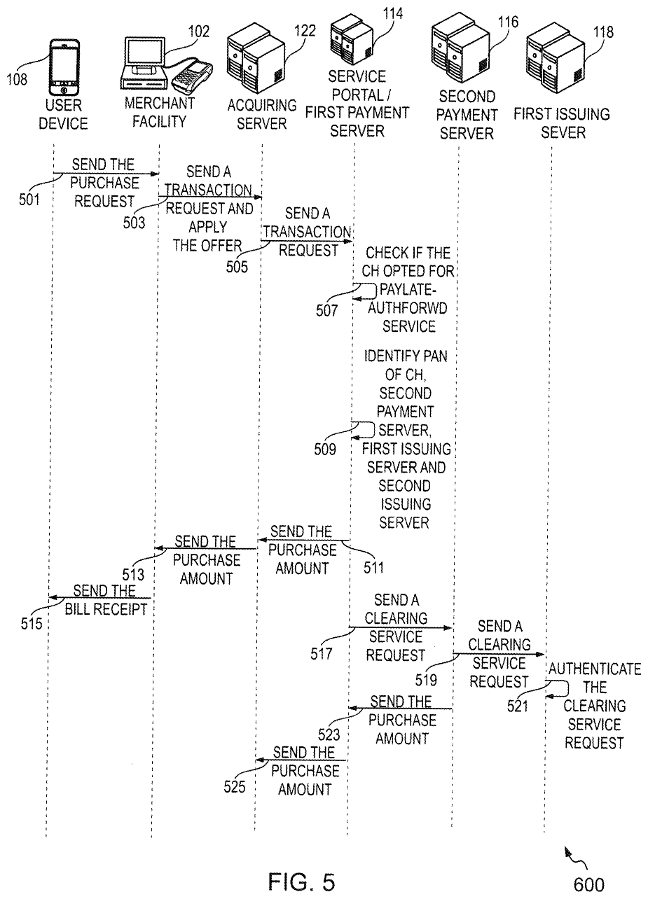

FIG. 5 illustrates a sequence flow diagram representing yet another method 500 of performing a transaction using the PayLateAuthForwd service in accordance with an example embodiment. FIG. 5 is in conjunction with FIG. 4.

At 501, the cardholder 110 sends a purchase request to purchase a product or a service at the merchant 102. The purchase request indicates buying a product or a service at the merchant facility 102 using the virtual card 132. The purchase of the product or the service comes with an offer if bought by a card (such as the virtual card 132) issued by the second payment entity 118. The cardholder 110 is willing to avail the offer and it is assumed that the cardholder 110 has already registered for the PayLateAuthForwd service and obtained the virtual card 132 issued by the second payment entity 118. The offer comprises, but not limited to, at least one of a discount, a cashback or any other benefit on buying the product or the service.

In an example embodiment, the merchant facility 102 receives the purchase request and reads the details of the virtual card 126 presented by the cardholder 110 to purchase the product or the service. At 503, the merchant 102 sends a transaction request including the details of the virtual card 132 and the price of the product or the service to the acquiring server 122. The merchant 102 has applied the offer as the virtual card 132 is issued by the second issuing server 120 providing the offer and accordingly processed the transaction request. The transaction request indicates a transaction performed by the cardholder 110 at the merchant 102 to buy the product or the service.

At 505, the acquiring service 122 sends the transaction request to the first payment server 114. At 507, the first payment server 114 checks whether the cardholder 110 has opted for the PayLateAuthForwd service against the virtual card 132 used for the transaction. The first payment server 114 verifies that the cardholder 110 has opted for the PayLateAuthForwd service based on presence of payment card 126 mapped against the virtual card 132 in the database of the first payment server 114.

At 509, the first payment server 114 de-tokenizes the virtual card number read from the virtual card 132 and then identifies the payment card 126 based on mapping the virtual card 132 with the payment card 126 according to the mapping information stored in the database. It is noted that the mapping information is already stored during by the first payment server 114 during registration for the PayLateAuthForwd service and generation of the virtual card 132 by the second issuing server 120. The first payment server 114 identifies the second issuing server 120 from the details of the virtual card 132. The first payment server 114 identifies the first issuing server 118 and the second payment server 116 from the details of the payment card 126 which are obtained from the mapping information.

At 511, the first payment server 114 sends an amount equivalent to the price of the product or the service after applying the offer to the acquiring server 122. At 513, the acquiring server 122 sends the amount received from the first payment server 114 to the merchant 102. At 515, the merchant 102 shares a bill receipt with the cardholder 110 indicating successful completion of purchase of the product or the service with the applicable offer. The bill receipt can be at least one of a paper receipt, a message or an email.

At 517, the first payment server 114 sends a transaction clearing request to the second payment server 116 identified in the step 509. The transaction clearing request includes a transaction amount spent by the cardholder 110 during purchase of the product or the service using the PayLateAuthForwd service. The transaction amount is equivalent to the price of the product or the service purchased by the cardholder 110 after the offer was applied. The transaction clearing request also includes a service charge for rendering the PayLateAuthForwd service to the first issuing server 118 in order to gain more customers.

At 519, the second payment server 116 forwards the transaction clearing request to the first issuing server 118. At 521, the first issuing server 118 processes the transaction clearing request. At 523, the first issuing server 118 sends the transaction amount along with the service charge to the second payment server 116.

At 525, the second payment server 116 sends the transaction amount along with the service charge to the first payment server 114. The first payment server 114 may send the transaction clearing request to the second payment server 116 after each transaction performed by the cardholder 110 using the virtual card 132, or alternatively the first payment server 114 may send the transaction clearing to the second payment server 116 after every ‘n’ number of transactions performed by the cardholder 110 using the virtual card 132 (where ‘n’ is a numeral value such as 1, 2, 3, 4, . . . ), or the first payment server 114 may send the transaction clearing request for all the transactions made by the cardholder 110 during the time period limit after the time period limit expires.

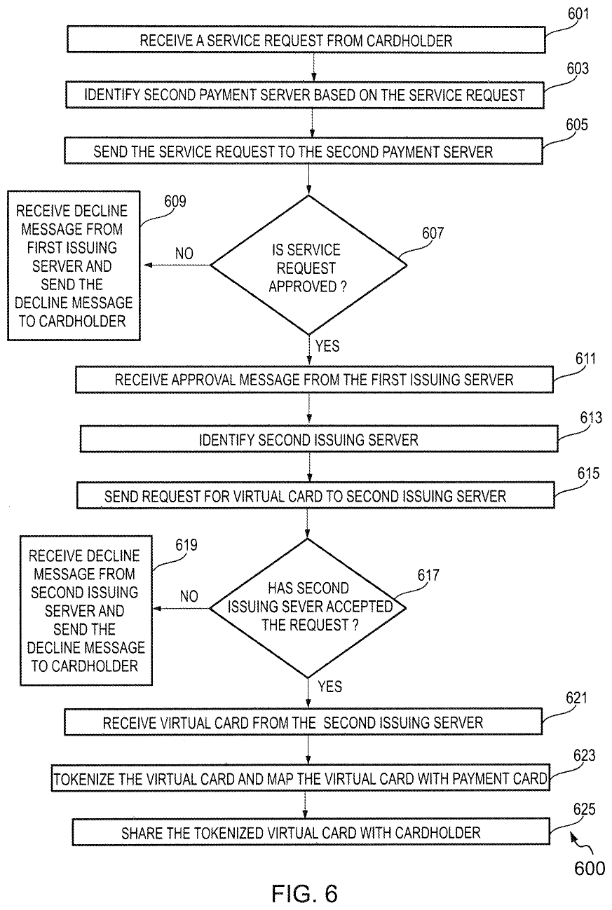

FIG. 6 illustrates a flow diagram representing a method 600 of facilitating registration for a PayLateAuthForwd service at a service portal 130 and generation of a virtual card 132 for a transaction made using the PayLateAuthForwd service, in accordance with an example embodiment.

At step 601, the service portal 130 receives a service request from the cardholder 110. The cardholder 110 visits a website 128 hosted by the first payment server 114 to access the service portal 130. The service portal 130 acts as a gateway and redirects the service request to a first payment entity such as the first payment server 114. The service request indicates request to opt for the PayLateAuthForwd service after successfully completing a login procedure at the service portal 130. The cardholder 110 has a payment card 126 issued by the first issuing server 118 in association with the second payment server 116. The cardholder 110 provides details such as card number, name on the card, expiry date, CVV, a transaction amount limit, a time period limit, and name of the second issuing server 120 in the service request. The cardholder 110 can raise the service request via the website 128 hosted by the first payment server 114 to access the service portal 130. Alternatively, the cardholder 110 can raise the service request by calling to a customer care number of the first payment server 114 and providing all the details including the card number of the payment card 126, name on the card, expiry date, CVV, the transaction amount limit, the time period limit, and name of the second issuing server 120. The transaction amount limit is updated after every transaction made by the cardholder 110 during usage of the PayLateAuthForwd service

At step 603, the first payment server 114 identifies the second payment server 116 based on the details of the payment card 126 shared by the cardholder 110 in the service request. At step 605, the first payment server 114 sends the service request to the second payment server 116.

The second payment server 116 sends the service request to the first issuing server 118 for approval on the transaction amount limit and the time period limit and also for the authentication of the details of the payment card 126 provided by the cardholder 110 in the service request.

The first issuing server 118 authenticates the details of the payment card 126 provided by the cardholder 110 in the service request, and checks whether the cardholder 110 has sufficient fund in his/her account at the first issuing server 118 in order to be eligible to avail the PayLateAuthForwd service with the mentioned transaction amount limit. For example, the first issuing server 118 can specify a criteria that the account balance of the cardholder 110 must be four times of the transaction amount limit in order to make the cardholder 110 eligible for availing the PayLateAuthForwd service. Further, the time period limit shall also expire before the expiry date of the payment card 126. Accordingly, the first issuing server 118 approves the transaction amount limit and the time period limit. The first issuing server 118 holds an amount equivalent to the transaction amount limit in the account of the cardholder 110.

At step 607, if the first issuing server 118 approves the service request the method 600 proceeds to step 611, otherwise the method 600 proceeds to step 609. At step 609, the first payment server 114 receives a decline message from the first issuing server 118 via the second payment server 116 indicating non-approval of the service request. The first payment server 114 sends the decline message to the cardholder 110 via the service portal 130 or the user device 108 along with a reason of declination of the service request such as low account balance or the time period limit exceeding the expiry date of the payment card 126.

At step 611, the first payment server 114 receives the approval message from the first issuing server 118. The first issuing server 118 sends an approval message to the second payment server 116 indicating approval on eligibility of the cardholder 110 for availing the PayLateAuthForwd service for the transaction amount limit and the time period limit. The second payment server 116 forwards the approval message to the first payment server 114.

At step 613, the first payment server 114 identifies the second issuing server 120 based on the details (i.e. name of the second issuing server 120) provided by the cardholder 110 in the service request.

At step 615, the first payment server 114 sends a service request to the second issuing server 120 for issuing a virtual card 132 and shares the details such as card number of the payment card 126. The second issuing server 120 check creditability score of the payment card 126 based on market standards programs for checking the creditability of any credit or debit cards. The second issuing server 120 issues the virtual card 132 based on the creditability score analysis of the payment card 126.

At step 617, if the second issuing server 120 accepts the request for issuing a virtual card 132 the method 600 proceeds to step 621 otherwise the method 600 proceeds to step 619. At 619, the second issuing server 120 sends a decline message to the to the first payment server 114, and the first payment server 114 sends the decline message to the cardholder 110 along with a reason of declination of the service request such as for example, but not limited to, low creditability score.

At step 621, the first payment server 114 receives the virtual card 132 from the second issuing server 120. At 623, the first payment server 114 tokenizes the virtual card for security purposes and maps the tokenized virtual card 132 with the payment card 126 issued by the first issuing server 118, and saves this mapping information in a database of the first payment server 114 for future reference and use.

At step 625, the first payment server 114 shares the tokenized virtual card 132 with the cardholder 110. The virtual card 132 may comprise a temporary card or a permanent card. In an alternate embodiment, the second issuing server 120 may also issue a physical card based on a request for the cardholder 110.

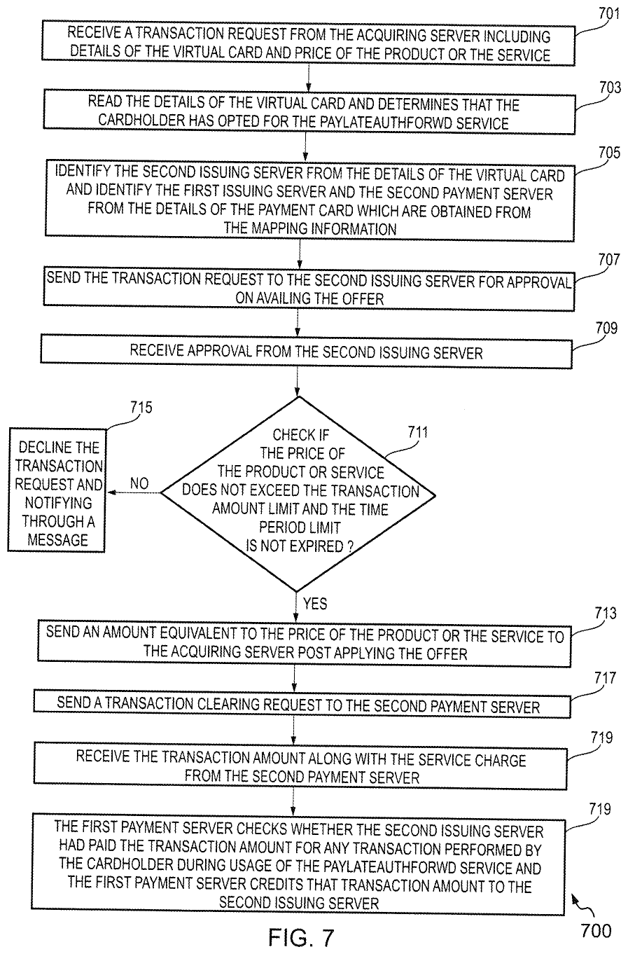

FIG. 7 illustrates a flow diagram representing a method 700 of performing a transaction using the PayLateAuthForwd service in accordance with an example embodiment.

At step 701, the first payment server 114 receives a transaction request from the acquiring server 122. Previously, the cardholder 110 has sent a purchase request to purchase a product or a service at the merchant 102. The purchase request indicates buying a product or a service at the merchant facility 102 using the virtual card 132. The purchase of the product or the service comes with an offer if bought by a card (such as the virtual card 132) issued by the second payment entity 118. The cardholder 110 is willing to avail the offer and therefore the cardholder 110 has already registered for the PayLateAuthForwd service and obtained the virtual card 132 issued by the second payment entity 118. The offer comprises including but not limited to at least one of a discount, a cashback or any other benefit on buying the product or the service. The merchant 102 sent a transaction request along with the details of the virtual card 132 and the price of the product or the service to the acquiring server 122. The merchant 102 had applied the offer as the virtual card 132 is issued by the second issuing server 120 providing the offer and accordingly processed the transaction request. The transaction request indicates a transaction performed by the cardholder 110 at the merchant 102 to buy the product or the service.

At step 703, the first payment server 114 reads the details of the virtual card 132 and determines that the cardholder 110 has opted for the PayLateAuthForwd service against the virtual card 132 used for the transaction. The first payment server 114 determines that the cardholder 110 has opted for the PayLateAuthForwd service based on presence of payment card 126 mapped against the virtual card 132 in the database of the first payment server 114. The first payment server 114 de-tokenizes the virtual card number read from the virtual card and then identifies the payment card 126 based on mapping the virtual card 132 with the payment card 126 according to the mapping information stored in the database of the first payment server 114 during registration for the PayLateAuthForwd service and generation of the virtual card 132 by the second issuing server 120.

At step 705, the first payment server 114 identifies the second issuing server 120 from the details of the virtual card 132. The first payment server 114 identifies the first issuing server 118 and the second payment server 116 from the details of the payment card 126 which are obtained from the mapping information.

At step 707, the first payment server 114 sends the transaction request to the second issuing server 120 for approval on availing the offer. At step 709, receive approval from the second issuing server 120.

At step 711, the first payment server 114 checks if the price of the product or service does not exceed the transaction amount limit and the time period limit is not expired. If the price of the product or service does not exceed the transaction amount limit and the time period limit is not expired the method 700 proceeds to step 713 otherwise proceeds to step 715.

At step 713, the first payment server 114 sends an amount equivalent to the price of the product or the service after applying the offer to the acquiring server 122. The acquiring server 122 sends the amount received from the first payment server 114 to the merchant 102. The merchant 102 shares a bill receipt with the cardholder 110 indicating successful completion of purchase of the product or the service with the applicable offer. The bill receipt can be at least one of a paper receipt, a message or an email.

At step 715, the first payment server 114 sends the decline message to the cardholder 110 along with a reason of declination of the service request such as insufficient transaction amount limit or expiring of the time period limit.

At step 717, the first payment server 114 sends a transaction clearing request to the second payment server 116. The transaction clearing request includes a transaction amount spend by the cardholder 110 during purchase of the product or the service using the PayLateAuthForwd service. The transaction amount is equivalent to the price of the product or the service purchased by the cardholder 110 after the offer was applied. The transaction clearing request also includes a service charge for rendering the PayLateAuthForwd service to the first issuing server 118 in order to gain more customers.

The first payment server 114 may send the transaction clearing request to the second payment server 116 after each transaction performed by the cardholder 110 using the virtual card 132, or alternatively the first payment server 114 may send the transaction clearing to the second payment server 116 after every n number of transactions performed by the cardholder 110 using the virtual card 132 (where n is an integral value such as 1, 2, 3, 4, . . . ), or the first payment server 114 may send the transaction clearing request for all the transactions made by the cardholder 110 during the time period limit after the time period limit expires. The second payment server 116 forwards the transaction clearing request to the first issuing server 118. The first issuing server 118 processes the transaction clearing request. The first issuing server 118 sends the transaction amount along with the service charge to the second payment server 116.

At step 719, the first payment server 114 receives the transaction amount along with the service charge from the second payment server 116.

At step 721, the first payment server 114 checks whether the second issuing server 120 had paid the transaction amount for any transaction performed by the cardholder 110 during usage of the PayLateAuthForwd service and the first payment server 114 credits that transaction amount to the second issuing server 120.

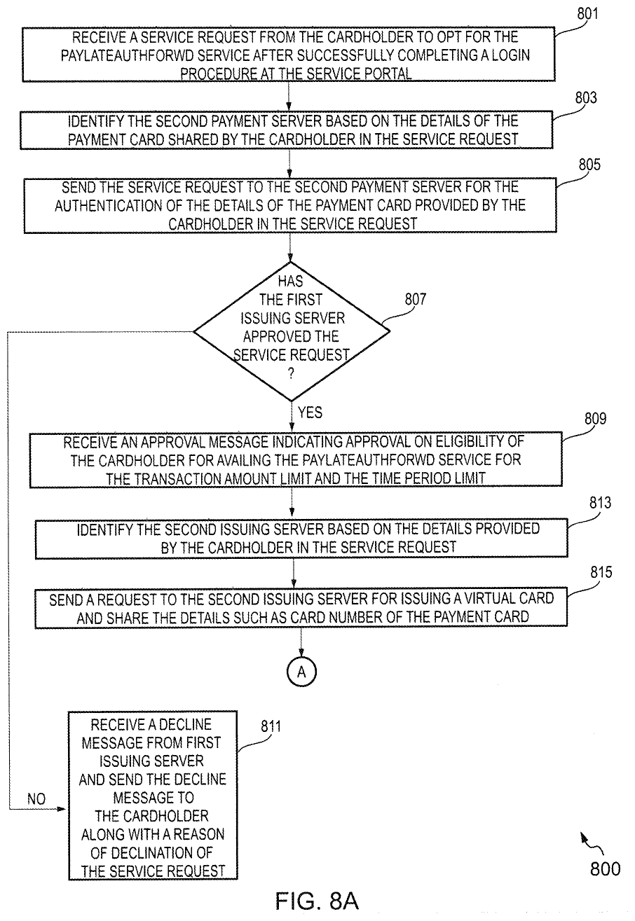

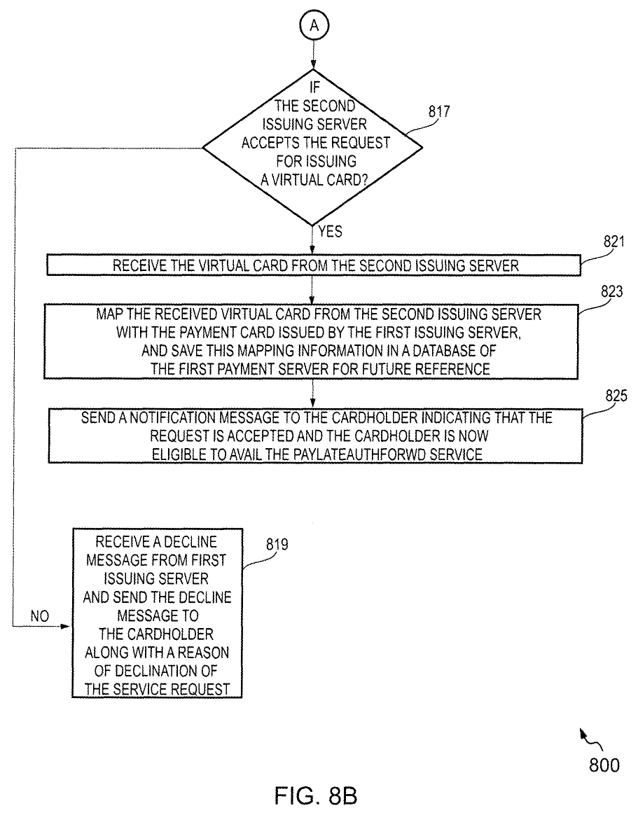

FIGS. 8A and 8B in conjunction illustrates a flow diagram representing yet another method 800 of facilitating registration for a PayLateAuthForwd service at a service portal 130 and generation of a virtual card 132 for a transaction made using the PayLateAuthForwd service, in accordance with an example embodiment. The method 800 depicted in the flow diagram may be executed by, for example, the first payment server 114. Operations of the flow diagram of the method 800, and combinations of operation in the flow diagram, may be implemented by, for example, hardware, firmware, a processor, circuitry and/or a different device associated with the execution of software that includes one or more computer program instructions. The sequence of operations of the method 800 need not be necessarily executed in the same order as they are presented. Further, one or more operations may be grouped together and performed in form of a single step, or one operation may have several sub-steps that may be performed in parallel or in sequential manner.

At step 801, the service portal 130 receives a service request from the cardholder 110. The cardholder 110 visits a website 128 hosted by the first payment server 114 to access the service portal 130. The service portal 130 redirects the service request to the first payment server 114. The service request indicates request to opt for the PayLateAuthForwd service after successfully completing a login procedure at the service portal 130. The cardholder 110 has a payment card 126 issued by the first issuing server 118 in association with the second payment server 116. The cardholder 110 provides details such as card number, name on the card, expiry date, CVV, a transaction amount limit, a time period limit, and name of the second issuing server 120 in the service request. The cardholder 110 has raised the service request via the website 128 hosted by the first payment server 114 to access the service portal 130. Alternatively, the cardholder 110 can raise the service request by calling to a customer care number of the first payment server 114 and provide all the details including the card number of the payment card 126, name on the card, expiry date, CVV, the transaction amount limit, the time period limit, and name of the second issuing server 120. The transaction amount limit is updated after every transaction made by the cardholder 110 during usage of the PayLateAuthForwd service

At step 803, the first payment server 114 identifies the second payment server 116 based on the details of the payment card 126 shared by the cardholder 110 in the service request. At step 805, the first payment server 114 sends the service request to the second payment server 116 for the authentication of the details of the payment card 126 provided by the cardholder 110 in the service request.

The second payment server 116 sends the service request to the first issuing server 118 for approval on the transaction amount limit and the time period limit and also for the authentication of the details of the payment card 126 provided by the cardholder 110 in the service request.

The first issuing server 118 authenticates the details of the payment card 126 provided by the cardholder 110 in the service request, and checks whether the cardholder 110 has sufficient fund in his/her account at the first issuing server 118 in order to be eligible to avail the PayLateAuthForwd service with the mentioned transaction amount limit. For example, the first issuing server 118 can specify a criteria that the account balance of the cardholder 110 must be four times than the transaction amount limit in order to make the cardholder 110 eligible for availing the PayLateAuthForwd service. Further, the time period limit shall also expire before the expiry date of the payment card 126. Accordingly, the first issuing server 118 approves the transaction amount limit and the time period limit. The first issuing server 118 holds an amount equivalent to the transaction amount limit in the account of the cardholder 110.

At step 807, if the first issuing server 118 approves the service request the method 800 proceeds to step 809 and at step 809 the first payment server 114 receives an approval message indicating approval on eligibility of the cardholder 110 for availing the PayLateAuthForwd service for the transaction amount limit and the time period limit via the second payment server 116, otherwise the method 800 proceeds to step 811. At step 811, the first payment server 114 receives a decline message from first issuing server 118 via the second payment server 116 indicating non-approval of the service request, and the first payment server 114 sends the decline message to the cardholder 110 along with a reason of declination of the service request such as low account balance or the time period limit exceeding the expiry date of the payment card 126.

At step 813, the first payment server 114 identifies the second issuing server 120 based on the details (i.e. name of the second issuing server 120) provided by the cardholder 110 in the service request.

At step 815, the first payment server 114 sends a request to the second issuing server 120 for issuing a virtual card 132 and shares the details such as card number of the payment card 126. The second issuing server 120 check creditability score of the payment card 126 based on market standards programs for checking the creditability of any credit or debit cards. The second issuing server 120 issues the virtual 132 based on the creditability score analysis of the payment card 126

At step 817, if the second issuing server 120 accepts the request for issuing a virtual card 132 the method 800 proceeds to step 819 otherwise the method 800 proceeds to step 821. At step 819, the first payment server 114 receives a decline message from second issuing server 120, and the first payment server 114 sends the decline message to the cardholder 110 along with a reason of declination of the service request such as for example, but not limited to, low creditability score.

At step 821, the first payment server 114 receives the virtual card 132 from the second issuing server 120. At step 823, the first payment server 114 maps the received virtual card 132 from the second issuing server 120 with the payment card 126 issued by the first issuing server 118, and save this mapping information in a database of the first payment server 114 for future reference and use. The first payment server 114 tokenizes the virtual card for security purposes. The tokenized virtual card is also saved along with the mapping information in the database.

At step 825, the first payment server 114 sends a notification message to the cardholder 110 indicating that the request is accepted and the cardholder 110 is now eligible to avail the PayLateAuthForwd service. The notification message also includes masked card number of the tokenized virtual card 132. Therefore, the first payment server 114 instead of sharing the virtual card 132, only shared partial details of the virtual card 132. The virtual card 132 may comprise a temporary card or a permanent card. In an alternate embodiment, the second issuing server 120 also issue a physical card based on a request for the cardholder 110.

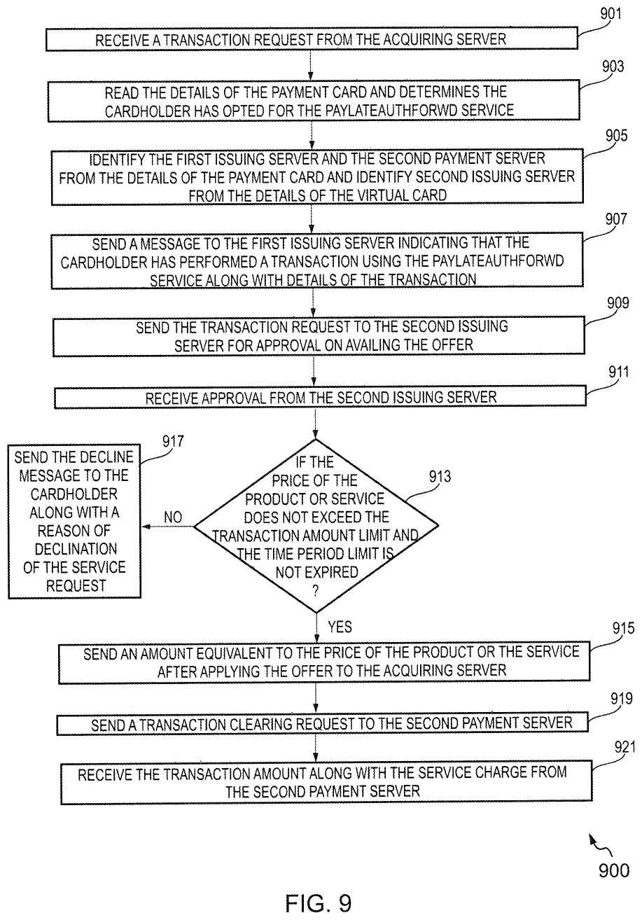

FIG. 9 illustrates a flow diagram representing yet another method 900 of performing a transaction using the PayLateAuthForwd service in accordance with an example embodiment. The method 900 depicted in the flow diagram may be executed by, for example, the first payment server 114. Operations of the flow diagram of the method 900, and combinations of operation in the flow diagram, may be implemented by, for example, hardware, firmware, a processor, circuitry and/or a different device associated with the execution of software that includes one or more computer program instructions. The sequence of operations of the method 900 need not be necessarily executed in the same order as they are presented. Further, one or more operations may be grouped together and performed in form of a single step, or one operation may have several sub-steps that may be performed in parallel or in sequential manner.

At step 901, the first payment server 114 receives a transaction request from the acquiring server 122. Previously, the cardholder 110 has sent a purchase request to purchase a product or a service at the merchant 102. The purchase request indicates the cardholder 110 buying a product or a service at the merchant facility 102 using the payment card 126. The purchase of the product or the service comes with an offer if bought by a card (such as the virtual card 132) issued by the second payment entity 118. The cardholder 110 is willing to avail the offer therefore the cardholder 110 has already registered for the PayLateAuthForwd service and obtained the virtual card 132 issued by the second payment entity 118 (as shown in FIG. 8). However, the cardholder 110 does not have possession of the virtual card 132 to use it directly at the merchant 102. The offer comprises at least one of a discount, a cashback or any other benefit on buying the product or the service from the merchant 102. The merchant 102 sent a transaction request including the details of the payment card 126 and the price of the product or the service to the acquiring server 122. The transaction request indicates a transaction performed by the cardholder 110 at the merchant 102 to buy the product or the service.

At step 903, the first payment server 114 reads the details of the payment card 126 and determines the cardholder 110 has opted for the PayLateAuthForwd service against the payment card 126 used for the transaction. The first payment server 114 determines that the cardholder 110 has opted for the PayLateAuthForwd service based on presence of the virtual card 132 mapped against the payment card 126 in the database of the first payment server 114.

The first payment server 114 identifies the virtual card 132 based on mapping the payment card 126 with the virtual card 132 according to the mapping information stored in the database of the first payment server 114 after generation of the virtual card 132 by the second issuing server 120 during registration for the PayLateAuthForwd service.

At step 905, the first payment server 114 identifies the first issuing server 118 and the second payment server 116 from the details of the payment card 126. The first payment server 114 identifies the second issuing server 120 from the details of the virtual card 132 which is obtained from the mapping information. At step 907, the first payment server 114 sends a message to the first issuing server 118 indicating that the cardholder 110 has performed a transaction using the PayLateAuthForwd service along with details of the transaction such as product or service purchased by the cardholder 110, merchant terminal details such as MCC, etc.

At step 909, the first payment server 114 sends the transaction request to the second issuing server 120 for approval on availing the offer. At step 911, receive approval from the second issuing server 120.

At step 913, the first payment server 114 checks if the price of the product or service does not exceed the transaction amount limit and the time period limit is not expired. If the price of the product or service does not exceed the transaction amount limit and the time period limit is not expired the method 900 proceeds to step 915 otherwise proceeds to step 917.

At step 915, the first payment server 114 sends an amount equivalent to the price of the product or the service after applying the offer to the acquiring server 122. The acquiring server 122 sends the amount received from the first payment server 114 to the merchant 102. The merchant 102 shares a bill receipt with the cardholder 110 indicating successful completion of purchase of the product or the service with the applicable offer. The bill receipt can be at least one of a paper receipt, a message or an email.

At step 917, the first payment server 114 sends the decline message to the cardholder 110 along with a reason of declination of the service request such as insufficient transaction amount limit or expiring of the time period limit.

At step 919, the first payment server 114 sends a transaction clearing request to the second payment server 116. The transaction clearing request includes a transaction amount spend by the cardholder 110 during purchase of the product or the service using the PayLateAuthForwd service. The transaction amount is equivalent to the price of the product or the service purchased by the cardholder 110 after the offer was applied. The transaction clearing request also includes a service charge for rendering the PayLateAuthForwd service to the first issuing server 118 in order to gain more customers.

The first payment server 114 send the transaction clearing request to the second payment server 116 after each transaction performed by the cardholder 110 using the virtual card 132, or alternatively the first payment server 114 may send the transaction clearing to the second payment server 116 after every n number of transactions performed by the cardholder 110 using the virtual card 132 (where n is a numeral value such as 1, 2, 3, 4, . . . ), or the first payment server 114 may send the transaction clearing request for all the transactions made by the cardholder 110 during the time period limit after the time period limit expires. The second payment server 116 forwards the transaction clearing request to the first issuing server 118. The first issuing server 118 processes the transaction clearing request. The first issuing server 118 sends the transaction amount along with the service charge to the second payment server 116.

At step 921, the first payment server 114 receives the transaction amount along with the service charge from the second payment server 116.

At step 923, the first payment server 114 checks whether the second issuing server 120 had paid the transaction amount for any transaction performed by the cardholder 110 during usage of the PayLateAuthForwd service and the first payment server 114 credits that transaction amount to the second issuing server 120.

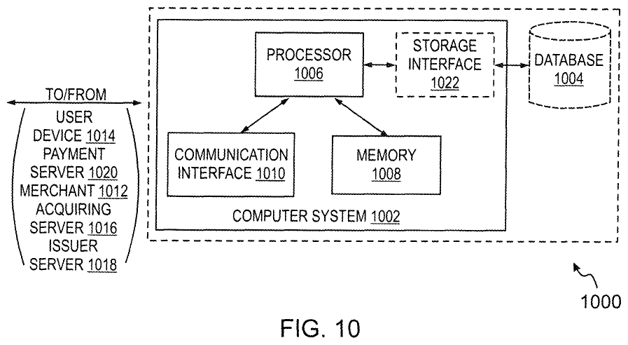

FIG. 10 is a simplified block diagram of a server system 1000 for rendering a service (e.g., the PayLateAuthForwd service) to the cardholder 110, in accordance with an embodiment of the present disclosure. Examples of the server system 1000 include, but not limited to, the first payment server 114 illustrated in FIG. 1. The server system 1000 includes a computer system 1002 and a database 1004.

The computer system 1002 includes at least one processor 1006 for executing instructions. Instructions may be stored in, for example, but not limited to, a memory 1008. The processor 1006 may include one or more processing units (e.g., in a multi-core configuration).

The processor 1006 is operatively coupled to a communication interface 1010 such that the computer system 1002 is capable of communicating with a remote device such as a merchant terminal 1012 (e.g., the merchant terminal 102), a user device 1014 (e.g., the user device 108), an acquiring server 1016 (e.g., the acquiring server 122), an issuing server 1018 (e.g., the issuing server 118 or the issuing server 120), a payment server 1020 (e.g., the payment server 116) or communicates with any entity within the network 112. For example, the communication interface 1010 may receive a registration request from the user device 1014 for registration for a PayLateAuthForwd service provided by the server system 1000. The cardholder 110 can register by accessing a website hosted by the first payment server 114 with the payment card 126 of the customer or cardholder 110 and/or a payment transaction request from the merchant terminal 1012 for payment of at least a part of a transaction amount of a transaction made using PayLateAuthForwd service the at the merchant terminal 1012.

The processor 1006 may also be operatively coupled to the database 1004. The database 1004 is any computer-operated hardware suitable for storing and/or retrieving data, such as, but not limited to, transaction data generated as part of sales activities conducted over the bankcard network including data relating to merchants, account holders or customers, and purchases. The database 1004 may also store information related to a plurality of user's issuer accounts. Each user account data includes at least one of a cardholder name, a cardholder address, an account number, virtual cards linked with a payment card of the cardholder, a transaction amount balance in each of the one or more virtual cards, a merchant identifier of the merchant rendering the offer, validity of the one or more virtual cards, and other account identifier. The database 1004 may also store information of a plurality of merchants, plurality of merchant terminals installed at merchant facilities, such as merchant terminal ID, location of merchant terminals etc. The database 1004 may also include instructions for settling transactions including merchant bank account information, determining balance amount to be debited from the issuer account of the cardholder based on transaction amount of transactions made using the PayLateAuthForwd service. The database 1004 may include multiple storage units such as hard disks and/or solid-state disks in a redundant array of inexpensive disks (RAID) configuration. The database 1004 may include a storage area network (SAN) and/or a network attached storage (NAS) system. In one embodiment, the communication interface 1010 includes a transceiver for wirelessly communicating information to, or receiving information from, the acquiring server 1016 or other suitable display device, and/or another type of remote processing device. In another embodiment, the communication interface 1010 is capable of facilitating operative communication with the remote devices and a cloud server using Application Program Interface (API) calls. The communication may be achieved over a communication network.

In some embodiments, the database 1004 is integrated within the computer system 1002. For example, the computer system 1002 may include one or more hard disk drives as the database 1004. In other embodiments, the database 1004 is external to the computer system 1002 and may be accessed by the computer system 1002 using a storage interface 1022. The storage interface 1022 is any component capable of providing the processor 1006 with access to the database 1004. The storage interface 1022 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1006 with access to the database 1004.

The processor 1006 is configured to process a payment of the transaction amount from plurality of transactions performed by the cardholder 110 using the virtual card under the PayLateAuthForwd service to an acquirer account (merchant account). The processor 1006 is configured to receive a registration request for registration for a PayLateAuthForwd service provided by the server system 1000, send the registration request for verification to either another payment network such as payment network 1020 or issuing server 1080 and send a request to the issuing server 1018 (e.g., the second issuing server 120) to issue a virtual card linked with the payment card. The processor 1006 shares the virtual card either completely or partially with the cardholder 110 via the communication interface 1010. In a non-limiting manner, the PayLateAuthForwd service renders an option to the cardholder 110 to perform a transaction without paying any money at the time of making the transaction and can choose a timeline within the cardholder 110 can pay back the money. The PayLateAuthForwd service also renders an option to the cardholder 110 to select the issuing server 1018 (e.g., second issuing server 120) for providing the virtual card so that the cardholder 110 can avail the offer provided by the issuing server 1018 (e.g., the second issuing server 120) while making the transaction to purchase the product or the service having the offer. The processor 1006 is further configured to perform one or more of the functions such as: receive a payment transaction request from the acquiring server 1016, send the money to the acquiring server 1012 for the transactions made by the cardholder 110 using the PayLateAuthForwd service provided by the server system 1000. The processor 1016 is further configured to send a transaction clearing request to the issuing server 1018 (e.g., first issuing server 118), receive money from the issuer bank (for example first issuing server 118) linked with the payment card of the cardholder 110. The processor 1006 is further configured to check the authentication of the cardholder 110 by verifying the payment card number, PIN/OTP or QR code, validity of the payment card by accessing respective information from the database 1004. Thereafter, the processor 1006 is configured to process the payment transaction of the transaction amount from the issuer account of the customer 114 to the acquirer account of the merchant 102. The processor 1006 may also be configured to notify the merchant terminal 1012 and/or the user device 1014 of the transaction status via the communication interface 1010.

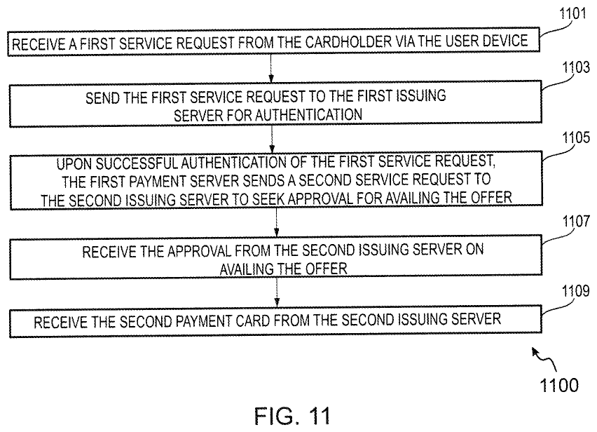

FIG. 11 illustrates a flow diagram of a method 1100 for performing a transaction using the PayLateAuthForwd service, in accordance with another example embodiment of present disclosure. The method 1100 depicted in the flow diagram may be executed by a payment server such as the first payment server 114. Operations of the flow diagram of the method 1100, and combinations of operations in the flow diagram, may be implemented by, for example, hardware, firmware, a processor, circuitry and/or a different device associated with the execution of software that includes one or more computer program instructions. The operations of the method 1100 are described herein with help of the first payment server 114, however, it is noted that the operations of the method 1100 can be described and/or practiced by using a system other than the first payment server 114, for example by the acquiring server 122, the first issuing server 118, the second issuing server 120 or the second payment server 116 or their combination. It should further be noted that the some operations of the method 1100 can be combined to be performed in a single operation and/or one operation of the method 1100 may be executed in multiple steps.

At step 1102, the first payment server 114 receives a first service request from the cardholder 110 via the user device 108. The first service request is a request from the cardholder 110 to facilitate the PayLateAuthForwd service provided by the first payment server 114 so that the cardholder 110 can avail an offer using a first payment card of the cardholder 110 associated with the first issuing server 118, the offer provided by a second issuing server 120. The first service request includes details such as card number of the first payment card, name on the first payment card, expiry date of the first payment card, CVV on the first payment card, the transaction amount limit, the time period limit, and name of the second issuing server 120.

At step 1104, the first payment server 114 sends the first service request to the first issuing server 118 for authentication. The first issuing server 118 authenticates the details of the first payment card (for example the payment card 126) provided by the cardholder 110 in the service request, and checks whether the cardholder 110 has sufficient fund in his/her account at the first issuing server 118 in order to be eligible to avail the PayLateAuthForwd service with the mentioned transaction amount limit. Accordingly, the first issuing server 118 approves the transaction amount limit and the time period limit.

At step 1106, upon successful authentication of the first service request, the first payment server 114 sends a second service request to the second issuing server 120 to seek approval for availing the offer provided by the second issuing server 120. The second issuing server 120 check creditability score of the first payment card based on market standards programs for checking the creditability of any credit or debit cards. The second issuing server 120 accepts the second service request based on the creditability score analysis of the first payment card.

At step 1108, the first payment server 114 receives the approval from the second issuing server 120 on availing the offer. The first payment server 114 further requests the second issuing server 120 to the issue a second payment card (for example, but not limiting to, the virtual card 132).

At step 1110, the first payment receives the second payment card from the second issuing server 120.

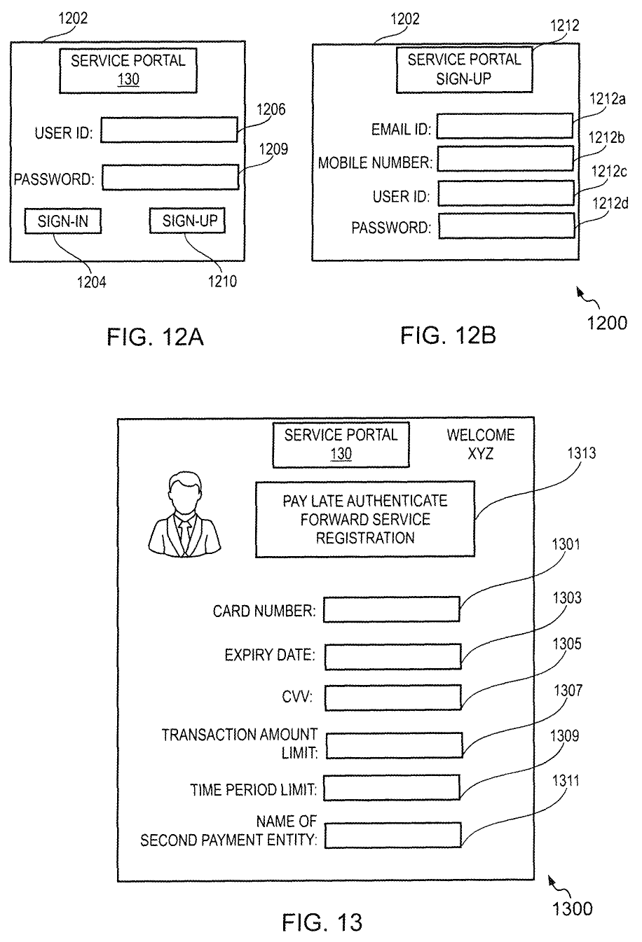

Referring now to FIG. 12, an example representation of a UI 1200 displayed to the cardholder 110 on a display screen of the user device 108 configured to render selection inputs registration for the PayLateAuthForwd service, is illustrated in accordance with another example embodiment of the present disclosure.

The UI 1200 render selection inputs such as sign-in or sign-up on the display screen 1202 of the user device 108 to register for the PayLateAuthForwd service via the service portal 130 hosted by the first payment service 114. If the cardholder 110 is a member of the first payment server 114 and has registered for the PayLateAuthForwd service, by choosing sign-in selection input 1204 and providing the login credentials i.e. a user-id 1206 and a password 1208, the cardholder 110 can enter into the service portal 130 hosted by the first payment server 114. The cardholder 110, who wants to login as new registration, selects sign-up selection input 1210. The cardholder 110 is re-directed to a sign-up page 1212 and fill details such as an email-id 1212a, a mobile number 1212b, and creates a login credential i.e. user-id 1212c and password 1212d, and enter into the service portal 130 hosted by the first payment server 114. Now, the cardholder 110 registered as a new member can login using the user-id 1212c and password 1212d into the service portal 130. The UI 1200 may be presented to the cardholder 110 on the user device 108 via an application interface. In at least one example embodiment, the UI 1200 may be displayed on the user device 108 on the display screen of the merchant interface device 106.

Referring now to FIG. 13, an example representation of a UI 1300 is displayed to the cardholder 110 on a display screen of the user device 108. The UI 300 is configured to facilitate provision of raising a service request at the service portal 130 of the first payment server 114 after the cardholder 110 signs in the service portal 130 with the login credentials.

The UI 1300 renders multiple input data fields such as a card number 1301, an expiry date 1303, a CVV 1305, a transaction amount limit 1307, a time period limit 1309 and a name of the second issuing server 1311, and a selection input PayLateAuthForwd Service 1313 on the display screen 1202 of the user device 108 to select the PayLateAuthForwd service via the service portal 130 hosted by the first payment service 114.

The cardholder 110 fills respective data in the multiple input data fields and selects the selection input PayLateAuthForwd Service 1313 to avail the service. The cardholder 110 is then re-directed to the first payment server 114 which hosts the service portal 130.

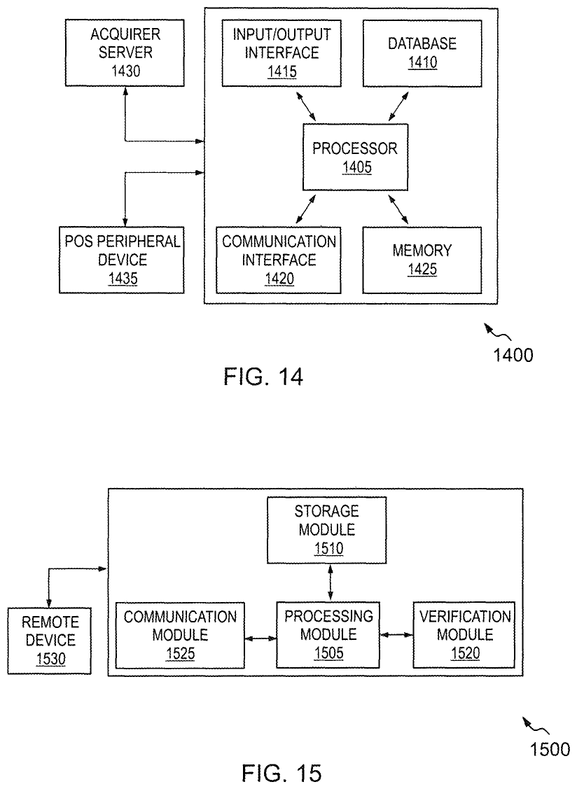

Referring now to FIG. 14, a simplified block diagram of a merchant terminal 1400 such as the merchant terminal 102 used for card based payment transaction, in accordance with one embodiment of the present disclosure. The merchant terminal 1400 as explained herein is only one example of the merchant terminal 102. In various embodiments, the merchant terminal 1400 can be a merchant mobile phone, a kiosk, a PDA, a merchant facilitated e-commerce website interface running on a computing device and the like. The merchant terminal 1400 includes at least one processor 1405 communicably coupled to a database 1410, an Input/Output (I/O) interface 1415, a communication interface 1420 and a memory 1425. The components of the merchant terminal 1400 provided herein may not be exhaustive, and that the merchant terminal 1400 may include more or fewer components than that of depicted in FIG. 14. Further, two or more components may be embodied in one single component, and/or one component may be configured using multiple sub-components to achieve the desired functionalities. Some components of the merchant terminal 1400 may be configured using hardware elements, software elements, firmware elements and/or a combination thereof.

An I/O interface 1415 is configured to receive inputs from and provide outputs to the end-user (i.e. the merchant and/or the customer) of the merchant terminal 1400. For instance, the I/O interface 1415 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 1425 can be any type of storage accessible to the processor 1405. For example, the memory 1425 may include volatile or non-volatile memories, or a combination thereof. In some non-limiting examples, the memory 1425 can be four to sixty four MegaBytes (MB) of Dynamic Random Access Memory (“DRAM”) or Static Random Access Memory (“SRAM”). In addition, some examples may include supplementary flash memory installed via a PCMCIA slot.

The database 1410 is capable of storing and/or retrieving data, such as, but not limited to, smart card insertions, user/customer information, merchant information, payment strings uniquely associated with each user, touch-screen key depressions, keypad key depressions, number of dots printed by the slip and roll printers, check read errors, card swipes, such as, plurality of number pad values of the payment card and the like. Such information can be accessed by the processor 1405 using the communication interface 1420 to determine potential future failures and the like.

The merchant terminal 1400 is capable of communicating with one or more POS peripheral devices such as a POS peripheral device 1435 and external server system such as an acquiring server 1430 (an example of the acquiring server 122 of FIG. 1) via the communication interface 1420. The POS peripheral device 1435 can provide functionality which is used by a consumer at a merchant facility, such as PIN entry, merchant transaction amount entry, clear text entry, signature capture, and the like. Some non-exhaustive examples of the POS peripheral device 1435 include POS card reader device, barcode scanner, cash drawer, receipt printer, PIN pad, signature capture device, touchscreen, keyboard, portable data terminal, customer pole display and the like. In some embodiments, the merchant terminal 1400 may be mounted near a cash register at a check-out counter in the merchant facility, while the POS peripheral device 1435 may be mounted on the check-out counter such that it is accessible to the users. In this way, both the merchant and the user/customer can interact with similar devices to process the payment transaction.

The communication interface 1420 is further configured to cause display of user interfaces on the merchant terminal 1400. In one embodiment, the communication interface 1420 includes a transceiver for wirelessly communicating information to, or receiving information from, the acquiring server 1430 or other suitable display device, and/or another type of remote processing device. In another embodiment, the communication interface 1420 is capable of facilitating operative communication with the remote devices and a cloud server using Application Program Interface (API) calls. The communication may be achieved over a communication network.

The processor 1405 is capable of sending the transaction request received from the end-user via the communication interface 1420 to the acquiring server 1430 for processing the transaction. For example, the processor 1405 is configured to receive the payment card information of the cardholder 110, PIN and the transaction amount via the POS peripheral device 1435. The processor 1405 can access the database 1410 to retrieve the user information and merchant information that are required to be sent along with the transaction request to the acquiring server 1430.

Additionally, the merchant terminal 1400 can include an operating system and various software applications that can provide various functionality to the merchant terminal 1400. For example, in some embodiments, the merchant terminal 1400 is addressable with an Internet protocol and includes a browser application. In such embodiments, the processor 1405 includes software adapted to support such functionality. In some embodiments, the processor 1405 executes software to support network management. In particular, this capacity allows software to be downloaded to a plurality of such systems to provide new applications such as application for enabling payment string based payment transactions using POS terminals and/or updates to existing applications. The operating system and software application upgrades are distributed and maintained through communication to the merchant terminal 1400 over the communication network.

Referring now to FIG. 15, a simplified block diagram of an issuing server 1500, in accordance with one embodiment of the present disclosure. The issuing server 1500 is an example of the first issuing server 118 or the second issuing server 120 of FIG. 1 or may be embodied in the issuing server 118. The issuing server 1500 is associated with an issuer bank/issuer, in which a cardholder 110 may have an account, which provides a payment card. The issuing server 1500 includes a processing module 1505 operatively coupled to a storage module 1510, a verification module 1520 and a communication module 1525. The components of the issuing server 1500 provided herein may not be exhaustive and that the issuing server 1500 may include more or fewer components than that of depicted in FIG. 15. Further, two or more components may be embodied in one single component, and/or one component may be configured using multiple sub-components to achieve the desired functionalities. Some components of the issuing server 1500 may be configured using hardware elements, software elements, firmware elements and/or a combination thereof.

The storage module 1510 is configured to store machine executable instructions to be accessed by the processing module 705. Additionally, the storage module 1510 stores information related to, contact information of the customer, bank account number, availability of funds in the account, payment card details, and/or the like. This information is retrieved by the processing module 1505.

The processing module 1505 is configured to communicate with one or more remote devices such as a remote device 1530 using the communication module 1525 over a network such as the network 112 of FIG. 1. The examples of the remote device 1530 include the merchant terminal 102, the first payment server 114, the acquiring server 122 and the network 112 and the like. The communication module 1525 is capable of facilitating such operative communication with the remote devices and cloud servers using API (Application Program Interface) calls. The communication module 1525 is configured to receive service request for issuing payment cards to avail the offers provided by the issuing server 1500. The communication module 1525 is configured to receive a transaction clearing amount from the first payment server 114 via the network 112. In some example embodiments, the processor 1505 is configured to receive the transaction clearing amount from the first payment server 114.

The verification module 1520 is configured to verify and validate a customer (such as the cardholder 110), the payment card 126 or the virtual card 132 associated with the cardholder 110 and a PIN of the payment card 126 for approving the transaction. The verification module 1520 may also verify if an issuer account of the customer associated with the payment card 126 have good standing balance. The communication module 1525 is configured to send notification of approval or decline of a transaction to the merchant terminal 102 via the network 112.

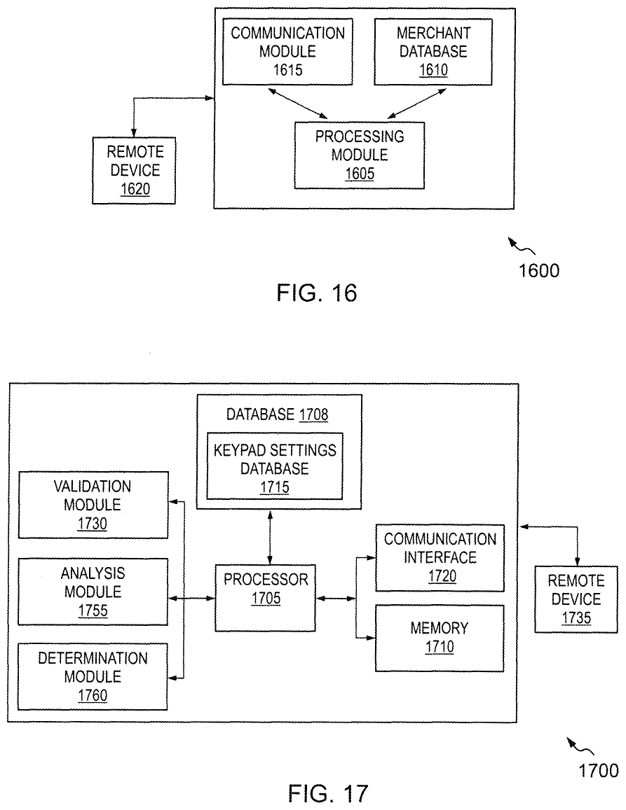

Referring now to FIG. 16, a simplified block diagram of an acquiring server 1600 used for card based payment transaction, in accordance with one embodiment of the present disclosure. The acquiring server 1600 is associated with an acquirer bank, which may be associated with a merchant (e.g., the merchant facility 102) at whose facility the cardholder 110 is purchasing goods. The merchant may have established an account to accept payment for purchase of goods from customers. The acquiring server 1600 is an example of the acquiring server 122 of FIG. 1 or may be embodied in the acquiring server 122. Further, the acquiring server 1600 is configured to facilitate transaction with the issuing server 1500 using a network, such as the network 112 of FIG. 1. The acquiring server 1600 includes a processing module 1605 communicably coupled to a merchant database 1610 and a communication module 1615. The components of the acquiring server 1600 provided herein may not be exhaustive, and that the acquiring server 1600 may include more or fewer components than that of depicted in FIG. 16. Further, two or more components may be embodied in one single component, and/or one component may be configured using multiple sub-components to achieve the desired functionalities. Some components of the acquiring server 800 may be configured using hardware elements, software elements, firmware elements and/or a combination thereof.

The merchant database 1610 includes a table which stores one or more merchant parameters, such as, but not limited to, a merchant primary account number (PAN), a merchant name, a merchant ID (MID), a merchant category code (MCC), a merchant city, a merchant postal code, an MAID, a merchant brand name, terminal identification numbers (TIDs) associated with merchant terminals (e.g., the POS terminals or any other merchant electronic devices) used for processing transactions, among others. The processing module 1605 is configured to use the MID or any other merchant parameter such as the merchant PAN to identify the merchant during the normal processing of payment transactions, adjustments, chargebacks, end-of-month fees, loyalty programs associated with the merchant and so forth. The processing module 1605 may be configured to store and update the merchant parameters in the merchant database 1610 for later retrieval. In an embodiment, the communication module 1615 is capable of facilitating operative communication with a remote device 1620.

In some embodiments, the acquiring server 1600 may be configured to communicate with the POS terminal 1400 using the communication module 1615.

FIG. 17 is a simplified block diagram of a payment server 1700 used for facilitating card based payment transaction between cardholder 110 and multiple issuing entities, in accordance with one embodiment of the present disclosure. The payment server 1700 may correspond to the first payment server 114 or the second payment server 116 of FIG. 1. The network 112 may be used by the payment server 1700, the issuing server 1500 and the acquiring server 1600 as a payment interchange network. Examples of payment interchange network include, but not limited to, Mastercard® payment system interchange network. The payment server 1700 includes a processor 1705 configured to extract programming instructions from a memory 1710 to provide various features of the present disclosure. The components of the payment server 1700 provided herein may not be exhaustive and that the payment server 1700 may include more or fewer components than that of depicted in FIG. 17. Further, two or more components may be embodied in one single component, and/or one component may be configured using multiple sub-components to achieve the desired functionalities. Some components of the payment server 1700 may be configured using hardware elements, software elements, firmware elements and/or a combination thereof.

Via a communication interface 1720, the processor 1705 receives a transaction request from a remote device 1735 such as the acquiring server 1600 or the merchant terminal 102. The communication may be achieved through API calls, without loss of generality. A keypad settings database 1715 is embodied in a database 1708 of the payment server 1700. The keypad settings database 1715 stores information corresponding to a customized electronic number pad settings of an electronic number pad from a plurality of customers. The keypad settings database 1715 is in operative communication with a validation module 1730, an analysis module 1755, and a determination module 1760.

The determination module 1760 is configured to receive a plurality of transaction requests associated with a plurality of payment cards 126 or virtual cards 132 via the communication interface 1720. The determination module 1760 is configured to determine whether the transaction is applicable for the PayLateAuthForwd service and further determines the issuing server (such as the first issuing server 118 and the second issuing server 120) and payment networks (such as the second payment server 116) associated with the payment card 126 or the virtual card 132. The determination module 1760 is further configured to determine mapped payment card 126 linked with the virtual card 132 or vice versa. In some embodiments, the analysis module 1755 receives the plurality of transaction requests associated with the plurality of card payment transactions done using the payment card 126 or the virtual card 132 using the PayLateAuthForwd service via the communication interface 1720. The analysis module 1755 is configured to determine whether the price of the product or service exceeds the transaction amount limit and the time period limit is expired or not.

The memory 1710 stores details such as Issuer ID, POS ID, country code, acquirer ID, payment card details, acquirer account information, transaction records, merchant account information, and the like. The customer details, the payment card details, the issuer account balance, etc. are validated using the validation module 1730. The validation module 1730 may include one or more predefined rule sets using which the processor 1705 can process the validation. Further, the processor 905, upon successful validation, sends the transaction amount to the acquiring server 1600.

The processor 1705 is further configured to notify the remote device 1735 of the transaction status via the communication interface 1720. The remote devices, as an example, may be the merchant terminal 102, the merchant interface device 106, the first issuing server 118, and the acquiring server 122. In one embodiment, the processor 1705 may facilitate a dedicated software application (also referred to as ‘the application interface’) capable of being installed on the user device 108. The cardholder 110 may access the application interface for registration and request for the PayLateAuthForwd service via the user device 108. The cardholder 110 may access the application interface using a web link as well, instead of having a need to install the application on the user device 108.

Without in any way limiting the scope, interpretation, or application of the claims appearing below, a technical effect of one or more of the example embodiments disclosed herein is to provide methods and systems for facilitating a transaction between a cardholder, registered with a first payment entity, and a second payment entity other than the first payment entity. More specifically, the second payment entity is promoting an offer which the cardholder wants to avail. The first payment entity and the second payment entity are connected via a server system. The embodiments facilitate the cardholder with provision of availing an offer provided by the second payment entity by registering to a service portal and opting for a pay later authentication forwarding (hereinafter, “PayLateAuthForwd”) service. The first payment entity and the second payment entity come into agreement to provide the facility for the user of PayLateAuthForwd request and routing transaction from first payment entity to the second payment entity which provides the offer to the product and approve/decline for the certain transactions or durations. Hence, the present disclosure helps in eliminating the need of carrying multiple cards from different payment entities in order to avail offers. Now, the cardholder can easily avail the offers from multiple payment entities in real-time processing without the need of having an account with the multiple payment entities and carrying multiple cards. The multiple payment entities also get benefited as being able to connect to multiple potential users which later may want to open accounts with them permanently. The interchange payment servers also gets benefit by charging fees for providing the PayLateAuthForwd from both the cardholder and the payment entities. Moreover, the present disclosure makes the process of availing offer more fast, convenient and financial beneficent.

The disclosed methods with reference to FIGS. 1 to 17, or one or more operations of the flow diagrams 600, 700, 800, 900 and 1100 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server systems (e.g., the servers 114, 116, 118, and 120) and its various components such as the computer system and the database may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method of performing at least one transaction, the method comprising:
receiving a first service request from a cardholder at a server system associated with a first payment entity, the first service request being a request to avail an offer using a first payment card of the cardholder associated with the first payment entity, the offer provided by a second payment entity;
facilitating authentication of the first service request at the first payment entity;
upon successful authentication of the first service request, sending a second service request to the second payment entity;
receiving an approval from the second payment entity for availing the offer based on the second service request; and
receiving a second payment card from the second issuing entity in response to sending a request to the second issuing entity for issuing the second payment card, the second payment card being eligible for availing the offer provided by the second payment entity.

2. The method according to claim 1, wherein the first payment entity is a first payment server and the second payment entity is a second payment server.

3. The method as claimed in claim 2,
wherein facilitating the authentication of the first service request comprises sending, by the first payment server, the first service request for the authentication to a first issuing server which issued the first payment card, and
wherein the second payment card is a virtual card, and receiving the second payment card further comprises mapping the virtual card to the first payment card by the first payment server.

4. The method according to claim 1, wherein the first payment entity is a first issuing server and the second payment entity is a second issuing server.

5. The method as claimed in claim 4,
wherein facilitating the authentication of the first service request comprises checking credentials of the cardholder and the first payment card, by the first issuing server by accessing a database having stored a plurality of credentials of a plurality of cardholders and a plurality of payment cards, and
wherein the second payment card is a virtual card, and receiving the second payment card further comprises mapping the virtual card to the first payment card by the first issuing server.

6. The method according to claim 1, wherein the first service request comprises a card number of the first payment card, a name of the cardholder of the first payment card, an expiry date of the first payment card, an amount requested by the cardholder, and a security code printed the first payment card.

7. The method according to claim 6, wherein the second service request comprises a name of the cardholder, an address of the cardholder, a mobile number of the cardholder, an email-id of the cardholder, an identity proof of the cardholder and a primary account number of the cardholder.

8. The method according to claim 6, wherein the second payment card is at least one of a virtual card or a physical card based on a preference of the cardholder, wherein the second payment card has a credit limit equals to the amount requested by the cardholder, the second payment card is allocated to the cardholder for making the at least one transaction.

9. The method according to claim 6, further comprising approving a credit limit of the second payment card by the first payment entity.

10. The method according to claim 1, further comprising holding an amount equivalent to an approved credit limit of the first payment card by the first payment entity.

11. A server system, comprising:
a memory comprising instructions; and
at least one processor responsive to the instructions to perform:
receiving a first service request from a cardholder at by the server system associated with a first payment entity, the first service request being a request to avail an offer using a first payment card of the cardholder associated with the first payment entity, the offer provided by a second payment entity;
facilitating authentication of the first service request at the first payment entity;
upon successful authentication of the first service request, sending a second service request to the second payment entity;
receiving an approval from the second payment entity for availing the offer based on the second service request; and
receiving a second payment card from the second issuing entity in response to sending a request to the second issuing entity for issuing the second payment card, the second payment card being eligible for availing the offer provided by the second payment entity.

12. The server system according to claim 11, wherein the first payment entity is a first payment server and the second payment entity is a second payment server.

13. The server system according to claim 12,
wherein facilitating the authentication of the first service request comprises sending, by the first payment server, the first service request for the authentication to a first issuing server which issued the first payment card, and
wherein the second payment card is a virtual card, and receiving the second payment card further comprises mapping the virtual card to the first payment card by the first payment server.

14. The server system according to claim 11, wherein the first payment entity is a first issuing server and the second payment entity is a second issuing server.

15. The server system according to claim 14,
wherein facilitating the authentication of the first service request comprises checking credentials of the cardholder and the first payment card, by the first issuing server by accessing a database having stored a plurality of credentials of a plurality of cardholders and a plurality of payment cards, and
wherein the second payment card is a virtual card, and receiving the second payment card further comprises mapping the virtual card to the first payment card by the first issuing server.

16. The system according to claim 11, wherein the first service request comprises a card number of the first payment card, name of the cardholder of the first payment card, an expiry date of the first payment card, an amount requested by the cardholder, and a security code printed the first payment card.

17. The system according to claim 11, wherein the second service request comprises a name of the cardholder, an address of the cardholder, a mobile number of the cardholder, an email-id of the cardholder, an identity proof of the cardholder and primary account number of the cardholder.

18. The system according to claim 11, wherein the second payment card corresponds to one of a virtual card or a physical card based on a preference of the cardholder, wherein the second payment card has a credit limit equals to the amount requested by the cardholder, the second payment card is allocated to the cardholder for making the at least one transaction.

19. A method of performing at least one transaction, the method comprising:
receiving a first service request from a cardholder at a server system associated with a first payment entity, the first service request being a request to avail an offer using a first payment card of the cardholder associated with the first payment entity, the offer provided by a second payment entity;
facilitating authentication of the first service request at the first payment entity;
upon successful authentication of the first service request, sending a second service request to the second payment entity;
receiving an approval from the second payment entity for availing the offer based on the second service request;
receiving a second payment card from the second issuing entity in response to sending a request to the second issuing entity for issuing the second payment card, the second payment card being eligible for availing the offer provided by the second payment entity; and
sending the second payment card to the cardholder via the server system.

20. The method according to claim 19, wherein the first service request comprises a card number of the first payment card, name of the cardholder on the first payment card, an expiry date of the first payment card, an amount requested by the cardholder, and a security code printed on the first payment card.
